(19) United States
(12) Patent Application Publication
(10) Pub. No.: US 2026/0050903 A1
(43) Pub. Date: Feb. 19, 2026

(54) Methods, Systems, and Electronic Devices for Contextually Identifying Divisions Associated with Digital Transactions

(71) Applicant: Motorola Mobility LLC, Chicago, IL (US)

(72) Inventors: Krishnan Raghavan, Bangalore (IN); Nakul Patel, Bangalore (IN); Lakshmana Hanuman Mahath Somina, Bangalore (IN)

(21) Appl. No.: 18/809,016

(22) Filed: Aug. 19, 2024

(51) Int. Cl. G06Q 20/22; G06Q 20/36; G10L 17/00

(52) U.S. Cl. CPC G06Q 20/22; G06Q 20/36; G10L 17/00

(57) ABSTRACT

A method in an electronic device involves detecting a financial transaction using a digital wallet application, capturing audio input from the environment, extracting audio samples to identify participants, and presenting a financial transaction dividing prompt on the user interface. The prompt can identify participants and their respective portions of the transaction amount. The system can split the transaction amount evenly or unevenly and allows for editing of participants. The method can include ceasing audio capture and deleting audio samples after transmitting reimbursement messages. The system uses contextual signals, such as calendar events and location data, to detect probable group transactions and capture relevant audio samples for accurate participant identification.

### BACKGROUND

### TECHNICAL FIELD

This disclosure relates generally to electronic devices, and more particularly to electronic devices having user interfaces.

### BACKGROUND ART

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card. It would be advantageous to have improved electronic devices and corresponding methods and systems that simplify this process.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory method in accordance with one or more embodiments of the disclosure.

FIG. 3 illustrates one explanatory system in accordance with one or more embodiments of the disclosure.

FIG. 4 illustrates one explanatory electronic device in accordance with one or more embodiments of the disclosure.

FIG. 5 illustrates another explanatory electronic device in accordance with one or more embodiments of the disclosure.

FIG. 6 illustrates still another explanatory electronic device in accordance with one or more embodiments of the disclosure.

FIG. 7 illustrates another explanatory electronic device in accordance with one or more embodiments of the disclosure.

FIG. 8A illustrates one or more method steps in accordance with one or more embodiments of the disclosure.

FIG. 8B illustrates one or more method steps in accordance with one or more embodiments of the disclosure.

FIG. 9 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to detecting, with one or more processors of the electronic device, a financial transaction having a transaction amount using a digital wallet application operable on the one or more processors of the electronic device, capturing, with an audio input device of the electronic device, audio input from an environment about the electronic device, extracting, by the one or more processors of the electronic device, one or more audio samples identifying one or more participants situated within the environment about the electronic device and participating in the financial transaction, and automatically presenting, by the one or more processors on a user interface of the electronic device, a financial transaction dividing prompt identifying the one or more participants participating in the financial transaction and a corresponding portion of the transaction amount assigned to each participant of the one or more participants. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, when one or more processors of an electronic device determine, from one or more audio signals captured by the audio input device, a plurality of individuals participating in a financial transaction executed by the digital wallet application and, in response, presenting a prompt identifying both the plurality of individuals and a financial transaction portion amount attributed to each individual of the plurality of individuals, wherein the prompt allows user input received by the user interface to manipulate the financial transaction portion amount attributed to the each individual of the plurality of individuals as described herein. The non-processor circuits may include, but are not limited to, a radio receiver, a radio transmitter, signal drivers, clock circuits, power source circuits, and user input devices.

As such, these functions may be interpreted as steps of a method to perform identifying, by one or more processors of the electronic device, one or more contextual signals indicative of a probable group electronic financial transaction occurring in a digital wallet application operating on the one or more processors, capturing, by an audio input device in response to the one or more contextual signals, audio samples from an environment of the electronic device, identifying, by the one or more processors from the audio samples, a group of individuals participating in the probable group electronic financial transaction, detecting, by the one or more processors from the digital wallet application, an actual financial transaction occurring, and presenting, by the one or more processors prior to completion of the actual financial transaction, a prompt identifying the group of individuals and facilitating a division of a transaction amount associated with the actual financial transaction into portions allocated to each individual associated with the group of individuals.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Motorola Mobility has launched a banking application called DIMO.sup.™ in Brazil. Digital banking applications such as DIMO.sup.™ are redefining banking. Indeed, DIMO.sup.™ already has almost five hundred thousand users of the system in Brazil as expects for that number to only continue to grow.

This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO.sup.™ are leading to users simply ceasing to carry paper currency or coins. Moreover, applications like DIMO.sup.™ have caused people to stop carrying physical credit and debit cards as well since the credit and debit card account information can simply be loaded into a smartphone, with near field and other communication devices allowing direct transactions of money electronically.

Embodiments of the disclosure contemplate that the rise of digital banking has led to a significant reduction in the use of paper cash and physical credit cards. Illustrating by example, some estimates suggest that over eighty percent of Brazil's population now holds at least one digital banking account. This shift has been accelerated by the pandemic and continues to grow.

Embodiments of the disclosure also contemplate that “bill splitting,” which is the practice of dividing expenses among a group, has become increasingly popular with the advent of mobile payment apps and digital platforms. However, despite the fact that a cottage bill splitting industry is expanding as more people adopt shared expenses and seek efficient ways to manage them, there are still problems in ensuring that a bill is split properly and properly allocated to the members of a bill splitting cohort.

Illustrating by example, while there are several present bill splitting solutions available, each requires users to manually enter details of shared expenses. This process is not only cumbersome but is further prone to errors. Users often face delays in collecting owed payments, and there is a risk of forgetting certain amounts over time. This manual process can also lead to embarrassment if someone is erroneously added to the bill who was not part of the event. Moreover, while existing solutions allow users to create predefined groups of friends for bill splitting, embodiments of the disclosure contemplate that the same set of people may not attend each event. This inconsistency necessitates the creation of new groups or manual editing of group members for each event. This adds to the complexity and inconvenience of the process.

Advantageously, embodiments of the disclosure provide a solution to this problem. To wit, embodiments of the disclosure provide electronic devices, systems, and methods addressing these issues by providing an automated and efficient way to identify bill split candidates. In one or more embodiments, the system monitors various contexts such as user location and upcoming events in the calendar to identify a bill payment requiring a split. In one or more embodiments, the system then gathers audio metadata to detect possible candidates for the bill split, intelligently turning on and off the audio gathering based on various factors. Once the audio gathering mode has been exited, the system reconciles the gathered data to arrive at a final list of candidates, which is then presented to the user for review and correction. The user can quickly send a payment request to participants once the details are tallied.

In one or more embodiments, a method in an electronic device comprises detecting, with one or more processors of the electronic device, a financial transaction having a transaction amount using a digital wallet application operable on the one or more processors of the electronic device. In one or more embodiments, the method comprises capturing, with an audio input device of the electronic device, audio input from an environment about the electronic device.

In one or more embodiments, the method comprises extracting, by the one or more processors of the electronic device, one or more audio samples identifying one or more participants situated within the environment about the electronic device and participating in the financial transaction. In one or more embodiments, the method comprises automatically presenting, by the one or more processors on a user interface of the electronic device, a financial transaction dividing prompt identifying the one or more participants participating in the financial transaction and a corresponding portion of the transaction amount assigned to each participant of the one or more participants.

Advantageously, by detecting a financial transaction using a digital wallet application and capturing audio input from the environment, the system can automatically identify participants involved in the transaction. This eliminates the need for manual entry of participant details, reducing the likelihood of errors and ensuring timely and accurate bill splitting.

The arrangement of capturing audio samples and extracting participant information allows the system to dynamically and contextually identify individuals present during the transaction. This is particularly useful in scenarios where participants may join or leave at different times, ensuring that the bill is split among the correct individuals.

Compared to existing solutions that rely on predefined groups or manual entry, this method offers a more flexible and automated approach. It adapts to real-time changes in the environment, such as the presence of multiple devices or the timing of a bill payment, to accurately identify participants.

This operational principle translates into a practical application by streamlining the bill-splitting process. Users can quickly review and confirm the identified participants, making adjustments if necessary, and send payment requests immediately. This reduces the burden on users and minimizes the potential for errors, enhancing the overall user experience.

For example, in a group dining scenario, the system can detect when the bill is paid and capture audio to identify who is present currently, and/or who was present during the event for an extended period. It then presents a prompt on the user interface with the identified participants and their respective shares, allowing the user to confirm and send payment requests without delay.

In one or more embodiments, an electronic device comprises a user interface, an audio input device, and one or more processors operable with the user interface and the audio input device and operating a digital wallet application. In one or more embodiments, the one or more processors are configured to determine, from one or more audio signals captured by the audio input device, a plurality of individuals participating in a financial transaction executed by the digital wallet application. In one or more embodiments, in response, the one or more processors are configured to present a prompt identifying both the plurality of individuals and a financial transaction portion amount attributed to each individual of the plurality of individuals. In one or more embodiments, the prompt allows user input received by the user interface to manipulate the financial transaction portion amount attributed to the each individual of the plurality of individuals.

The arrangement of the user interface, audio input device, and processors in the electronic device allows for the automatic identification of individuals participating in a financial transaction. By capturing audio signals from the environment and processing these signals to determine the participants, the system eliminates the need for manual entry of participant details, reducing the likelihood of errors and ensuring timely and accurate bill splitting.

This configuration enables the system to dynamically and contextually identify individuals present during the transaction, which is particularly useful in scenarios where participants may join or leave at different times. This ensures that the bill is split among the correct individuals, enhancing the accuracy and reliability of the process.

Compared to existing solutions that rely on predefined groups or manual entry, this method offers a more flexible and automated approach. It adapts to real-time changes in the environment, such as the presence of multiple devices or the timing of a bill payment, to accurately identify participants. This operational principle translates into a practical application by streamlining the bill-splitting process, allowing users to quickly review and confirm the identified participants, make necessary adjustments, and send payment requests immediately.

For example, in a group dining scenario, the system can detect when the bill is paid and capture audio to identify who is present currently, and can also infer who might have been present during the dining event for an extended period. It then presents a prompt on the user interface with the identified participants and their respective shares, allowing the user to confirm and send payment requests without delay. This reduces the burden on users and minimizes the potential for errors, enhancing the overall user experience.

In one or more embodiments, a method in an electronic device comprises identifying, by one or more processors of the electronic device, one or more contextual signals indicative of a probable group electronic financial transaction occurring in a digital wallet application operating on the one or more processors. In one or more embodiments, the method comprises capturing, by an audio input device in response to the one or more contextual signals, audio samples from an environment of the electronic device.

In one or more embodiments, the method comprises identifying, by the one or more processors from the audio samples, a group of individuals participating in the probable group electronic financial transaction. In one or more embodiments, the method comprises detecting, by the one or more processors from the digital wallet application, an actual financial transaction occurring.

In one or more embodiments, the method comprises presenting, by the one or more processors prior to completion of the actual financial transaction, a prompt identifying the group of individuals and facilitating a division of a transaction amount associated with the actual financial transaction into portions allocated to each individual associated with the group of individuals. In one or more embodiments, the identifying the group of individuals participating in the probable group electronic financial transaction comprises comparing the audio samples to one or more of previously captured voice call audio signals, previously captured video call audio signals, previously captured videos, or previously manually stored audio samples.

Advantageously, this method allows for effective bill splitting that occurs immediately and is automated to the extent possible, with users only needing to validate the details. Additionally, the system reliably identifies the people present at the event to ensure accurate bill splitting.

Thus, electronic devices, methods, and systems described herein automatically recognize candidates for splitting a bill based on audio samples taken around the event and subsequently sending payment requests to them after confirmation from the bill payer. Unlike existing solutions that require manual entry of participant details or rely on predefined groups, embodiments of the disclosure leverage contextual signals and audio metadata to dynamically and accurately identify individuals present during a financial transaction. This approach not only reduces the likelihood of errors but also ensures timely and accurate bill splitting, adapting to real-time changes in the environment such as the presence of multiple devices or the timing of a bill payment. The system's ability to intelligently turn on and off the audio gathering based on various factors further enhances its efficiency, user convenience, and privacy, making it a unique and innovative solution in the realm of digital financial transactions. Other advantages will be described below. Still others will be obvious to those of ordinary skill in the art having the benefit of this disclosure.

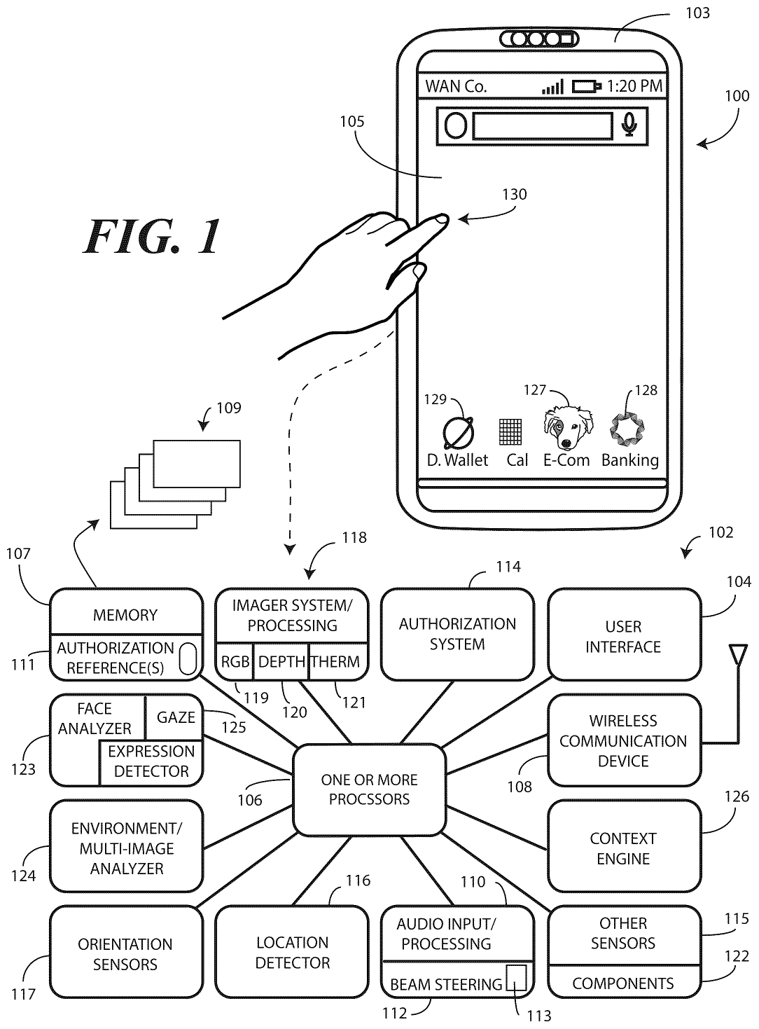

Turning now to FIG. 1, illustrated therein is one explanatory electronic device 100 in accordance with one or more embodiments of the disclosure. Also illustrated in FIG. 1 is one explanatory block diagram schematic 102 of the explanatory electronic device 100 of FIG. 1. In one or more embodiments, the block diagram schematic 102 is configured as a printed circuit board assembly disposed within a housing 103 of the electronic device 100. Various components can be electrically coupled together by conductors or a bus disposed along one or more printed circuit boards.

The illustrative block diagram schematic 102 of FIG. 1 includes many different components. Embodiments of the disclosure contemplate that the number and arrangement of such components can change depending on the particular application. Accordingly, electronic devices configured in accordance with embodiments of the disclosure can include some components that are not shown in FIG. 1, and other components that are shown may not be needed and can therefore be omitted.

The illustrative block diagram schematic 102 includes a user interface 104. In one or more embodiments, the user interface 104 includes a display 105, which may optionally be touch-sensitive. In one embodiment, users can deliver user input to the display 105 of such an embodiment by delivering touch input from a finger, stylus, or other objects disposed proximately with the display 105. In one embodiment, the display 105 is configured as an active matrix organic light emitting diode (AMOLED) display. However, it should be noted that other types of displays, including liquid crystal displays, suitable for use with the user interface 104 would be obvious to those of ordinary skill in the art having the benefit of this disclosure.

In one embodiment, the electronic device includes one or more processors 106. In one embodiment, the one or more processors 106 can include an application processor and, optionally, one or more auxiliary processors. One or both of the application processor or the auxiliary processor(s) can include one or more processors.

One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 102. Each of the application processor and the auxiliary processor(s) can be configured to process and execute executable software code to perform the various functions of the electronic device with which the block diagram schematic 102 operates. A storage device, such as memory 107, can optionally store the executable software code used by the one or more processors 106 during operation.

In one or more embodiments, the one or more processors 106 are responsible for running the operating system environment. The operating system environment can include a kernel, one or more drivers, and an application service layer, and an application layer. The operating system environment can be configured as executable code operating on one or more processors 106 or control circuits of the electronic device 100.

The application service layer can be responsible for executing application service modules. The application service modules may support one or more applications or “apps.” Examples of such applications include a cellular telephone application for making voice telephone calls, a web browsing application configured to allow the user to view webpages on the display 105 of the electronic device 100, an electronic mail application configured to send and receive electronic mail, a photo application configured to organize, manage, and present photographs on the display 105 of the electronic device 100, and a camera application for capturing images with the imager 119. Collectively, these applications constitute an “application suite.” In one or more embodiments, these applications comprise one or more e-commerce applications 127 and/or banking applications 128 that allow electronic commerce orders to be placed and financial transactions to be made using the electronic device 100.

Illustrating by example, in one or more embodiments a user can deliver user input to an e-commerce application 127 or a banking application 128 to enter an electronic payment transaction request or otherwise request an electronic payment transaction occur. In one or more embodiments, when this occurs, the one or more processors 106, using the audio input device, extract one or more contextual cues from the environment associated with the electronic payment transaction or electronic financial transaction.

In this illustrative embodiment, the block diagram schematic 102 also includes a communication circuit 108 that can be configured for wired or wireless communication with one or more other devices or networks. The networks can include a wide area network, a local area network, and/or personal area network. The communication circuit 108 may also utilize wireless technology for communication, such as, but are not limited to, peer-to-peer or ad hoc communications such as HomeRF, Bluetooth and IEEE 802.11, and other forms of wireless communication such as infrared technology. The communication circuit 108 can include wireless communication circuitry, one of a receiver, a transmitter, or transceiver, and one or more antennas.

In one embodiment, the one or more processors 106 can be responsible for performing the primary functions of the electronic device with which the block diagram schematic 102 is operational. For example, in one embodiment the one or more processors 106 comprise one or more circuits operable with the user interface 104 to present presentation information to a user. The executable software code used by the one or more processors 106 can be configured as one or more modules 109 that are operable with the one or more processors 106. Such modules 109 can store instructions, control algorithms, and so forth.

In one or more embodiments, the block diagram schematic 102 includes an audio input/processor 110. The audio input/processor 110 is operable to receive audio input from an environment about the electronic device 100. The audio input/processor 110 can include hardware, executable code, and speech monitor executable code in one embodiment. The audio input/processor 110 can be operable with one or more predefined authentication references 111 stored in memory 107.

With reference to audio input, the predefined authentication references 111 can comprise representations of basic speech models, representations of trained speech models, or other representations of predefined audio sequences that are used by the audio input/processor 110 to receive and identify voice commands that are received with audio input captured by an audio capture device. In one embodiment, the audio input/processor 110 can include a voice recognition engine. Regardless of the specific implementation utilized in the various embodiments, the audio input/processor 110 can access various speech models stored with the predefined authentication references 111 to identify speech commands.

The audio input/processor 110 can include a beam steering engine 112 comprising one or more microphones 113. Input from the one or more microphones 113 can be processed in the beam steering engine 112 such that the one or more microphones define a virtual microphone. This virtual microphone can define an acoustic reception cone that can be virtually “steered” around the electronic device 100. Alternatively, actual steering can occur as well, such as switching between a left and right microphone or a front and back microphone or switching various microphones ON and OFF individually. In one or more embodiments, two or more microphones 113 can be included for selective beam steering by the beam steering engine 112.

Illustrating by example, a first microphone can be located on a first side of the electronic device 100 for receiving audio input from a first direction, while a second microphone can be placed on a second side of the electronic device 100 for receiving audio input from a second direction. These microphones can be “steered”by selectively turning them ON and OFF.

The beam steering engine 112 can then select between the first microphone and the second microphone to beam steer audio reception toward an object, such as a user delivering audio input. This beam steering can be responsive to input from other sensors, such as imagers, facial depth scanners, thermal sensors, or other sensors. For example, an imager can estimate a location of a person's face and deliver signals to the beam steering engine 112 alerting it in which direction to focus the acoustic reception cone and/or steer the first microphone and the second microphone, thereby adding confirmation to audio steering and saving time. Where multiple people are around the electronic device 100, as was the case in FIG. 1, this steering advantageously directs a beam reception cone to the authorized user.

Alternatively, the beam steering engine 112 processes and combines the signals from two or more microphones to perform beam steering. The one or more microphones 113 can be used for voice commands. In response to control of the one or more microphones 113 by the beam steering engine 112, a user location direction can be determined. The beam steering engine 112 can then select between the first microphone and the second microphone to beam steer audio reception toward the user. Alternatively, the audio input/processor 110 can employ a weighted combination of the microphones to beam steer audio reception toward the user.

In one embodiment, the audio input/processor 110 is configured to implement a voice control feature that allows a user to speak a specific device command to cause the one or more processors 106 to execute a control operation. For example, the user may say, “Authenticate Me Now.” This statement comprises a device command requesting the one or more processors to cooperate with the authentication system 114 to authenticate a user. Consequently, this device command can cause the one or more processors 106 to access the authentication system 114 and begin the authentication process. In short, in one embodiment the audio input/processor 110 listens for voice commands, processes the commands and, in conjunction with the one or more processors 106, performs a touchless authentication procedure in response to voice input.

The one or more processors 106 can perform filtering operations on audio input received by the audio input/processor 110. For example, in one embodiment the one or more processors 106 can filter the audio input into authorized user generated audio input, i.e., first audio input, and other audio input, i.e., second audio input.

Various sensors 115 can be operable with the one or more processors 106. A first example of a sensor that can be included with the various sensors 115 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 106, to detect an object in close proximity with—or touching—the surface of the display 105 or the housing 103 of the electronic device 100 by establishing electric field lines between pairs of capacitive sensors and then detecting perturbations of those field lines.

The electric field lines can be established in accordance with a periodic waveform, such as a square wave, sine wave, triangle wave, or other periodic waveform that is emitted by one sensor and detected by another. The capacitive sensors can be formed, for example, by disposing indium tin oxide patterned as electrodes on the substrate. Indium tin oxide is useful for such systems because it is transparent and conductive. Further, it is capable of being deposited in thin layers by way of a printing process. The capacitive sensors may also be deposited on the substrate by electron beam evaporation, physical vapor deposition, or other various sputter deposition techniques.

Another example of a sensor 115 is a geo-locator that serves as a location detector 116. In one embodiment, location detector 116 is able to determine location data when authenticating a user. Location can be determined by capturing the location data from a constellation of one or more earth orbiting satellites, or from a network of terrestrial base stations to determine an approximate location. The satellite positioning systems based location fixes of the location detector 116 autonomously or with assistance from terrestrial base stations, for example those associated with a cellular communication network or other ground based network, or as part of a Differential Global Positioning System (DGPS), as is well known by those having ordinary skill in the art. The location detector 116 may also be able to determine location by locating or triangulating terrestrial base stations of a traditional cellular network, or from other local area networks, such as Wi-Fi networks.

One or more motion detectors can be configured as an orientation detector 117 that determines an orientation and/or movement of the electronic device 100 in three-dimensional space. Illustrating by example, the orientation detector 117 can include an accelerometer, gyroscopes, or other device to detect device orientation and/or motion of the electronic device 100. Using an accelerometer as an example, an accelerometer can be included to detect motion of the electronic device. Additionally, the accelerometer can be used to sense some of the gestures of the user, such as one talking with their hands, running, or walking.

The orientation detector 117 can determine the spatial orientation of an electronic device 100 in three-dimensional space by, for example, detecting a gravitational direction. In addition to, or instead of, an accelerometer, an electronic compass can be included to detect the spatial orientation of the electronic device relative to the earth's magnetic field. Similarly, one or more gyroscopes can be included to detect rotational orientation of the electronic device 100.

The authentication system 114 is operable with the one or more processors 106. A first authenticator 118 of the authentication system 114 can include an imager 119, a depth imager 120, and, optionally, a thermal sensor 121. In one embodiment, the imager 119 comprises a two-dimensional imager configured to receive at least one image of a person within an environment of the electronic device 100. In one embodiment, the imager 119 comprises a two-dimensional Red-Green-Blue (RGB) imager. In another embodiment, the imager 119 comprises an infrared imager. Other types of imagers suitable for use as the imager 119 of the authentication system will be obvious to those of ordinary skill in the art having the benefit of this disclosure.

The thermal sensor 121 can also take various forms. In one embodiment, the thermal sensor 121 is simply a proximity sensor component included with the other components 122 of the electronic device 100. In another embodiment, the thermal sensor 121 comprises a simple thermopile. In another embodiment, the thermal sensor 121 comprises an infrared imager that captures the amount of thermal energy emitted by an object. Other types of thermal sensors 121 will be obvious to those of ordinary skill in the art having the benefit of this disclosure.

The depth imager 120 can take a variety of forms. In a first embodiment, the depth imager 120 comprises a pair of imagers separated by a predetermined distance, such as three to four images. This “stereo” imager works in the same way the human eyes do in that it captures images from two different angles and reconciles the two to determine distance.

In another embodiment, the depth imager 120 employs a structured light laser. The structured light laser projects tiny light patterns that expand with distance. These patterns land on a surface, such as a user's face, and are then captured by an imager. By determining the location and spacing between the elements of the pattern, three-dimensional mapping can be obtained.

In still another embodiment, the depth imager 120 comprises a time of flight device. Time of flight three-dimensional sensors emit laser or infrared pulses from a photodiode array. These pulses reflect back from a surface, such as the user's face. The time it takes for pulses to move from the photodiode array to the surface and back determines distance, from which a three-dimensional mapping of a surface can be obtained. Regardless of embodiment, the depth imager adds a third “z-dimension” to the x-dimension and y-dimension defining the two-dimensional image captured by the imager 119, thereby enhancing the security of using a person's face as their password in the process of authentication by facial recognition.

In one or more embodiments, the authentication system 114 can be operable with a face analyzer 123 and an environmental analyzer 124. The face analyzer 123 and/or environmental analyzer 124 can be configured to process an image or depth scan of an object and determine whether the object matches predetermined criteria by comparing the image or depth scan to one or more predefined authentication references 111 stored in memory 107.

For example, the face analyzer 123 and/or environmental analyzer 124 can operate as an authentication module configured with optical and/or spatial recognition to identify objects using image recognition, character recognition, visible recognition, facial recognition, color recognition, shape recognition, and the like. Advantageously, the face analyzer 123 and/or environmental analyzer 124, operating in tandem with the authentication system 114, can be used as a facial recognition device to determine the identity of one or more persons detected about the electronic device 100.

In one embodiment when the authentication system 114 detects a person, one or both of the imager 119 and/or the depth imager 120 can capture a photograph and/or depth scan of that person. The authentication system 114 can then compare the image and/or depth scan to one or more predefined authentication references 111 stored in the memory 107. This comparison, in one or more embodiments, is used to confirm beyond a threshold authenticity probability that the person's face—both in the image and the depth scan—sufficiently matches one or more of the predefined authentication references 111 stored in the memory 107 to authenticate a person as an authorized user of the electronic device 100.

Beneficially, this optical recognition performed by the authentication system 114 operating in conjunction with the face analyzer 123 and/or environmental analyzer 124 allows access to the electronic device 100 only when one of the persons detected about the electronic device 100 are sufficiently identified as an authorized user of the electronic device 100.

Accordingly, in one or more embodiments the one or more processors 106, working with the authentication system 114 and the face analyzer 123 and/or environmental analyzer 124 can determine whether at least one image captured by the imager 119 matches a first predefined criterion, whether at least one facial depth scan captured by the depth imager 120 matches a second predefined criterion, and whether the thermal energy identified by the thermal sensor 121 matches a third predefined criterion, with the first criterion, second criterion, and third criterion being defined by the reference files and predefined temperature range.

The first criterion may be a skin color, eye color, and hair color, while the second criterion is a predefined facial shape, ear size, and nose size. The third criterion may be a temperature range of between 95 and 101 degrees Fahrenheit. In one or more embodiments, the one or more processors 106 authenticate a person as an authorized user of the electronic device 100 when the at least one image matches the first predefined criterion, the at least one facial depth scan matches the second predefined criterion, and the thermal energy matches the third predefined criterion.

In one or more embodiments, a user can “train” the electronic device 100 by storing predefined authentication references 111 in the memory 107 of the electronic device 100. These predefined authentication references 111 can be audio references, image references, depth scan references, or other types of references. Illustrating by example, the one or more processors 106 of the electronic device 100 may cause the one or more microphones 113 to capture audio samples of people situated within the environment of the electronic device 100 so that the same people can be identified at another time.

The audio input/processing module 110 can capture audio signals from the environment using one or more microphones 113. These audio signals can then be processed to extract relevant audio features. The audio input/processing module 110 can compare these extracted audio features to one or more predefined authentication references 111 stored in the memory 107. These predefined authentication references 111 may include voice samples from previous interactions, voice messages, or manually uploaded voice samples. By comparing the captured audio features to the stored references, the system can identify individuals present within the environment of the electronic device 100.

The audio input/processing module 110 can also employ a voice recognition engine to analyze the captured audio signals. This engine, where used, can extract voice recognition features and generate a voiceprint for each detected voice. The voice recognition engine can then compare these voiceprints to the predefined authentication references 111. If a match is found, the system can identify the individual associated with the voiceprint. This process allows the system to dynamically and contextually identify individuals present during a financial transaction or other events, ensuring accurate identification of participants.

In scenarios where multiple individuals are present, the audio input/processing module 110 can distinguish between different voices by analyzing voice characteristics such as pitch, tone, and speech patterns. The system can then cross-reference these characteristics with the predefined authentication references 111 to accurately identify each individual. This capability is particularly useful in environments where participants may join or leave at different times, ensuring that the system maintains an up-to-date and accurate list of individuals present.

Similarly, a user may take a series of pictures. They can include identifiers of special features such as eye color, sink color, air color, weight, and height. They can include the user standing in front of a particular wall, which is identifiable by the environmental analyzer from images captured by the imager 119. They can include the user raising a hand, touching hair, or looking in one direction, such as in a profile view. These can then be stored as predefined authentication references 111 in the memory 107 of the electronic device 100.

A gaze detector 125 can be operable with the authentication system 114 operating in conjunction with the face analyzer 123. The gaze detector 125 can comprise sensors for detecting the user's gaze point. The gaze detector 125 can optionally include sensors for detecting the alignment of a user's head in three-dimensional space. Electronic signals can then be processed for computing the direction of user's gaze in three-dimensional space. The gaze detector 125 can further be configured to detect a gaze cone corresponding to the detected gaze direction, which is a field of view within which the user may easily see without diverting their eyes or head from the detected gaze direction. The gaze detector 125 can be configured to alternately estimate gaze direction by inputting images representing a photograph of a selected area near or around the eyes. It will be clear to those of ordinary skill in the art having the benefit of this disclosure that these techniques are explanatory only, as other modes of detecting gaze direction can be substituted in the gaze detector 125 of FIG. 1.

The face analyzer 123 can include its own image/gaze detection-processing engine as well. The image/gaze detection-processing engine can process information to detect a user's gaze point. The image/gaze detection-processing engine can optionally also work with the depth scans to detect an alignment of a user's head in three-dimensional space. Electronic signals can then be delivered from the imager 119 or the depth imager 120 for computing the direction of user's gaze in three-dimensional space. The image/gaze detection-processing engine can further be configured to detect a gaze cone corresponding to the detected gaze direction, which is a field of view within which the user may easily see without diverting their eyes or head from the detected gaze direction. The image/gaze detection-processing engine can be configured to alternately estimate gaze direction by inputting images representing a photograph of a selected area near or around the eyes. It can also be valuable to determine if the user wants to be authenticated by looking directly at device. The image/gaze detection-processing engine can determine not only a gazing cone but also if an eye is looking in a particular direction to confirm user intent to be authenticated.

Other components 122 operable with the one or more processors 106 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 122 can also include proximity sensors. The proximity sensors fall in to one of two camps: active proximity sensors and “passive” proximity sensors. Either the proximity detector components or the proximity sensor components can be generally used for gesture control and other user interface protocols, some examples of which will be described in more detail below.

As used herein, a “proximity sensor component” comprises a signal receiver only that does not include a corresponding transmitter to emit signals for reflection off an object to the signal receiver. A signal receiver only can be used due to the fact that a user's body or other heat generating object external to device, such as a wearable electronic device worn by user, serves as the transmitter. Illustrating by example, in one the proximity sensor components comprise a signal receiver to receive signals from objects external to the housing 103 of the electronic device 100. In one embodiment, the signal receiver is an infrared signal receiver to receive an infrared emission from an object such as a human being when the human is proximately located with the electronic device 100. In one or more embodiments, the proximity sensor component is configured to receive infrared wavelengths of about four to about ten micrometers. This wavelength range is advantageous in one or more embodiments in that it corresponds to the wavelength of heat emitted by the body of a human being.

Additionally, detection of wavelengths in this range is possible from farther distances than, for example, would be the detection of reflected signals from the transmitter of a proximity detector component. In one embodiment, the proximity sensor components have a relatively long detection range so as to detect heat emanating from a person's body when that person is within a predefined thermal reception radius. For example, the proximity sensor component may be able to detect a person's body heat from a distance of about fifteen feet in one or more embodiments. The ten-foot dimension can be extended as a function of designed optics, sensor active area, gain, lensing gain, and so forth.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level. Simulations show that a group of infrared signal receivers can operate with a total current drain of just a few microamps.

In one embodiment, the signal receiver of each proximity sensor component can operate at various sensitivity levels so as to cause the at least one proximity sensor component to be operable to receive the infrared emissions from different distances. For example, the one or more processors 106 can cause each proximity sensor component to operate at a first “effective” sensitivity so as to receive infrared emissions from a first distance. Similarly, the one or more processors 106 can cause each proximity sensor component to operate at a second sensitivity, which is less than the first sensitivity, so as to receive infrared emissions from a second distance, which is less than the first distance. The sensitivity change can be affected by causing the one or more processors 106 to interpret readings from the proximity sensor component differently.

By contrast, proximity detector components include a signal emitter and a corresponding signal receiver, which constitute an “active IR” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

The other components 122 can optionally include a barometer operable to sense changes in air pressure due to elevation changes or differing pressures of the electronic device 100. Where included, in one embodiment the barometer includes a cantilevered mechanism made from a piezoelectric material and disposed within a chamber. The cantilevered mechanism functions as a pressure sensitive valve, bending as the pressure differential between the chamber and the environment changes. Deflection of the cantilever ceases when the pressure differential between the chamber and the environment is zero. As the cantilevered material is piezoelectric, deflection of the material can be measured with an electrical current.

The other components 122 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 100. Similarly, a temperature sensor can be configured to monitor temperature about an electronic device.

A context engine 126 can then be operable with the various sensors to detect, infer, capture, and otherwise determine persons and actions that are occurring in an environment about the electronic device 100. For example, where included one embodiment of the context engine 126 determines assessed contexts and frameworks using adjustable algorithms of context assessment employing information, data, and events. These assessments may be learned through repetitive data analysis. Alternatively, a user may employ the user interface 104 to enter various parameters, constructs, rules, and/or paradigms that instruct or otherwise guide the context engine 126 in detecting multi-modal social cues, emotional states, moods, and other contextual information. The context engine 126 can comprise an artificial neural network or other similar technology in one or more embodiments.

In one or more embodiments, the context engine 126 is operable with the one or more processors 106. In some embodiments, the one or more processors 106 can control the context engine 126. In other embodiments, the context engine 126 can operate independently, delivering information gleaned from detecting multi-modal social cues, emotional states, moods, and other contextual information to the one or more processors 106. The context engine 126 can receive data from the various sensors. In one or more embodiments, the one or more processors 106 are configured to perform the operations of the context engine 126.

In one or more embodiments, the one or more processors 106 can be operable with the various authenticators of the authentication system 114. For example, the one or more processors 106 can be operable with a first authenticator and a second authenticator. Where more authenticators are included in the authentication system 114, the one or more processors 106 can be operable with these authenticators as well.

As will be described in more detail below, in one or more embodiments the one or more processors 106 are configured to determine, from one or more audio signals captured by the audio input device defined by the audio input/processing module 110 and the one or more microphones 113, a plurality of individuals participating in a financial transaction executed by a digital wallet application 129 and, in response, to present a prompt identifying both the plurality of individuals and a financial transaction portion amount attributed to each individual of the plurality of individuals. In one or more embodiments, the prompt allows user input 130 received by the user interface 104 to manipulate the financial transaction portion amount attributed to the each individual of the plurality of individuals.

In one or more embodiments, the one or more processors 106, in response to the user input 130, alter the financial transaction portion amount attributed to the each individual of the plurality of individuals by an amount defined by the user input 130. In one or more embodiments, the prompt comprises a financial transaction portion reimbursement message transmission user actuation target. In one or more embodiments, the one or more processors 106, in response to actuation of the financial transaction portion reimbursement message transmission user actuation target, cause the communication device 108 to transmit a plurality of financial transaction portion reimbursement messages to a plurality of remote electronic devices belonging to the plurality of individuals.

In one or more embodiments, the one or more processors 106 further are configured to cause the audio input device to cease capturing the one or more audio signals in response to the presentation of the prompt. In one or more embodiments, the one or more processors 106 delete the one or more audio signals from the memory 107 in response to the communication device 108 transmitting the plurality of financial transaction portion reimbursement messages.

In one or more embodiments, the one or more processors 106 are responsible for managing the applications and all personal information received from the user interface 104 that is to be used by the finance application 127 and/or banking application 128 after the electronic device 100 is authenticated as a secure electronic device and the user identification credentials have triggered an electronic payment transaction request. The one or more processors 106 can also be responsible for launching, monitoring, and killing the various applications and the various application service modules.

In one or more embodiments, the one or more processors 106 are operable to not only kill the applications, but also to expunge any and all personal data, data, files, settings, or other configuration tools when the electronic device 100 is reported stolen or when the finance application 127 and/or banking application 128 are used with fraudulent activity to wipe the memory 107 clean of any personal data, preferences, or settings of the person previously using the electronic device 100.

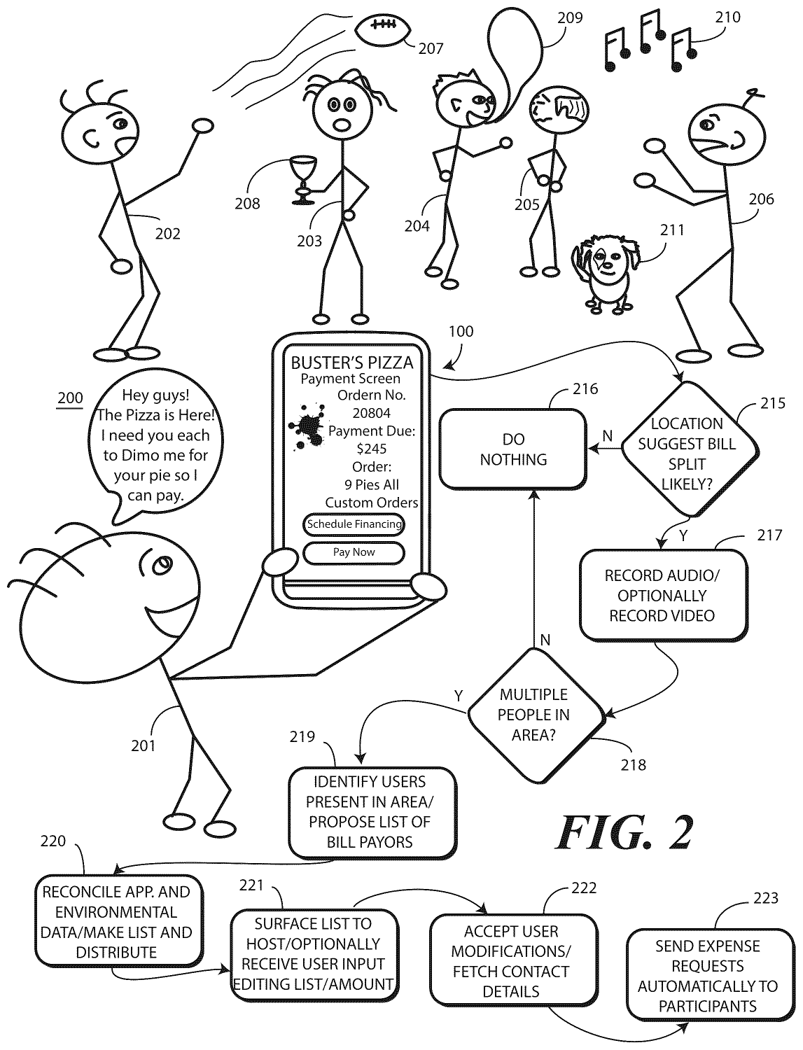

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components, and still be within the scope of the present disclosure.

Turning now to FIG. 2, illustrated therein is one explanatory system configured in accordance with one or more embodiments of the disclosure. An electronic device 100 is positioned within an environment 200. A plurality of persons 201,202,203,204,205,206 is situated within the environment 200 of the electronic device 100. Here, there are six persons 201,202,203,204,205,206 situated within the environment of the electronic device 100. Person 201, Nakul, is an authorized user of the electronic device 100.

Nakul organizes office outings to celebrate achievements and promote team bonding. Nakul enjoys coordinating these events but faces challenges in collecting individual shares from colleagues for shared expenses. In a recent instance, Nakul arranged a team outing and, as the organizer, paid for the activities. Despite prior notices and reminders, there was uncertainty about attendees until the day of the outing. After the outing, Nakul had to identify attendees, collect their contact information, and request payment.

While these challenges might have made Nakul reconsider organizing future team outings, in FIG. 2 Nakul is advantageously equipped with an electronic device 100 configured in accordance with embodiments of the present disclosure. The electronic device 100 can therefore execute a method to identify bill split candidates.

In one or more embodiments, one or more processors of the electronic device 100 identify one or more contextual signals indicative of a probable group electronic financial transaction occurring in a digital wallet application operating on the one or more processors. In one or more embodiments, the one or more processors can identify one or more contextual signals indicative of a probable group electronic financial transaction occurring in a digital wallet application operating on the one or more processors by monitoring various environmental and user-specific cues.

These contextual signals may include, but are not limited to, the detection of multiple electronic devices in close proximity, the presence of a calendar event stored in a calendaring application operating on the one or more processors indicating a group activity, or the identification of a specific location known for group gatherings, such as a restaurant or a shared workspace. The processors can utilize data from the device's location detector, calendar application, and communication circuits to gather these contextual signals.

For instance, the location detector can determine that the electronic device 100 is situated at a known merchant location where group transactions are common. Concurrently, the calendar application may indicate a scheduled event involving multiple participants. Additionally, the communication circuit can detect the presence of other electronic devices within a predefined range, suggesting a group setting. By correlating these signals, the one or more processors can infer the likelihood of a group financial transaction occurring.

Furthermore, the processors can analyze incoming notifications, such as group messages or event reminders, to identify potential group transactions. The system may also consider the timing of these signals, such as the proximity to a scheduled event or the duration of the devices'co-location, to enhance the accuracy of the contextual inference. By integrating these diverse data points, the processors can reliably identify scenarios indicative of a probable group electronic financial transaction, thereby enabling the digital wallet application to prepare for an efficient and automated bill-splitting process.

In one or more embodiments, an audio input device, in response to the one or more contextual signals, captures audio samples from the environment 200 of the electronic device 100. From these audio samples, as described above with reference to FIG. 1, the one or more processors can identify a group of individuals participating in the probable group electronic financial transaction. The one or more processors can then detect, from the digital wallet application, an actual financial transaction occurring. Thereafter, prior to the completion of the actual financial transaction in one or more embodiments, the one or more processors can present a prompt identifying the group of individuals and facilitating a division of a transaction amount associated with the actual financial transaction into portions allocated to each individual associated with the group of individuals.

In the illustrative embodiment of FIG. 2, persons 202,203,204,205,206 are friends, family, or acquaintances of the authorized user. Persons 202,203,204,205,206 may be authorized by the authorized user to use the electronic device 100 in one or more embodiments. In other embodiments, persons 202,203,204,205,206 may be unauthorized users of the electronic device 100.

In this illustration, used to more particularly describe various features and advantages of embodiments of the disclosure, there is a lot occurring. The scene set forth in the environment 200 of the electronic device 100 is not dissimilar to that which may occur at a family gathering, family reunion, school reunion, and so forth. In this illustration, person 202 is passing a football 207 to person 206. Person 203 is watching the action while sipping on a cocktail 208. Person 204 is having a conversation 209 with person 205. Music 210 is playing. A dog 211 is enjoying the weather and dreaming of his next meal.

Nakul has ordered pizza for the group. Ordinarily, splitting the bill among these persons 202,203,204,205,206, especially during this moment of joy and whimsy, would be nearly impossible. However, Nakul's electronic device 100, configured in accordance with one or more embodiments of the disclosure, can do this quickly, accurately, and automatically.

Beginning at decision 215, one or more processors of the electronic device 100 detect a financial transaction, which is the pizza order in this illustrative example, having a transaction amount using a digital wallet application operable on one or more processors of the electronic device 100. In one or more embodiments, the one or more processors detect a financial transaction having a transaction amount using a digital wallet application by monitoring the application for specific transaction-related events.

In one or more embodiments, the digital wallet application, operable on the one or more processors, generates transaction events when a user initiates or completes a financial transaction. These events include data packets containing transaction details such as the transaction amount, merchant information, and timestamp. The processors can continuously, or periodically, scan the digital wallet application's event logs or transaction history to identify these transaction events.

Upon detecting a transaction event, the processors extract the relevant transaction details from the data packets. This extraction process involves parsing the data packets to retrieve the transaction amount, which is a numerical value representing the monetary value of the transaction. The processors can also identify other contextual information associated with the transaction, such as the merchant's name, location, and the time of the transaction. This contextual information helps in correlating the transaction with potential bill-splitting scenarios.

In addition to monitoring the digital wallet application's internal events, the processors may also utilize external signals to confirm the occurrence of a financial transaction. These external signals can include notifications from banking servers, confirmation messages from payment gateways, or receipts sent to the user's email or messaging applications. By cross-referencing the internal transaction events with these external signals, the processors ensure the accuracy and validity of the detected financial transaction.

If no financial transaction is detected, step 216 does nothing. However, when a financial transaction having a transaction amount is detected, in one or more embodiments, an audio input device of the electronic device captures audio from the environment 200 of the electronic device 100 at step 217. Decision 218 then determines whether there are multiple people in the environment 200.

Decision 218, where the one or more processors of the electronic device 100 can determine whether audio samples of audio captured by the environment 200 identify one or more participants being situated in the environment 200 about the electronic device 100 while participating in a financial transaction detected by the one or more processors of the electronic device, as well as step 219 where these individuals are identified, can occur in a variety of ways. Illustrating by example, the audio input device can capture audio samples from the environment 200, which the one or more processors analyze to extract relevant audio features. These features may include voice characteristics such as pitch, tone, and speech patterns. The one or more processors can compare these extracted audio features to predefined authentication references stored in the memory of the electronic device 10. These predefined authentication references may include voice samples from previous interactions, voice messages, or manually uploaded voice samples.

By comparing the captured audio features to the stored references, the one or more processors can identify individuals present within the environment 200 of the electronic device 100. The one or more processors employ a voice recognition engine to analyze the captured audio signals, extracting voice recognition features and generating a voiceprint for each detected voice. The voice recognition engine then compares these voiceprints to the predefined authentication references. If a match is found, the system identifies the individual associated with the voiceprint. This process allows the system to dynamically and contextually identify individuals present during a financial transaction, ensuring accurate identification of participants.

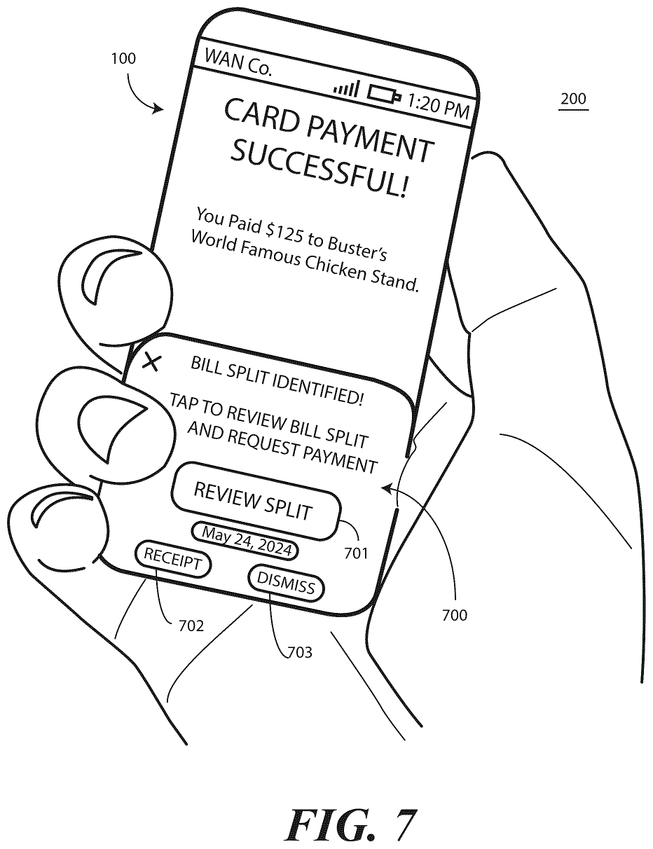

In scenarios where multiple individuals are present, the one or more processors distinguish between different voices by analyzing voice characteristics such as pitch, tone, and speech patterns. The system then cross-references these characteristics with the predefined authentication references to accurately identify each individual. This capability is particularly useful in environments where participants may join or leave at different times, ensuring that the system maintains an up-to-date and accurate list of individuals present. The one or more processors can then use this information to present a financial transaction dividing prompt on the user interface, identifying the participants and their corresponding portions of the transaction amount.

Where such individuals are identified, step 219 can further comprise automatically presenting, by the one or more processors on a user interface of the electronic device 100, a financial transaction dividing prompt identifying the one or more participants participating in the financial transaction and a corresponding portion of the transaction amount assigned to each participant of the one or more participants. Turning briefly to FIG. 7, illustrated therein is one such financial transaction dividing prompt 700.

In one or more embodiments, the financial transaction dividing prompt 700 is an initial financial transaction dividing prompt 700 indicating that a bill split situation has been identified. As noted above, in one or more embodiments this situation is detected when one or more audio samples extracted from an audio input captured from an environment 200 around the electronic device 100 identifies one or more participants situated within the environment 200 who are participating in the financial transaction.

Illustrating by example, the electronic device 100 first detects that a financial transaction is occurring. To do this, one or more processors of the electronic device 100 can monitor various contextual signals to identify such transactions. These signals include the detection of multiple electronic devices in close proximity, the presence of a calendar event indicating a group activity, or the identification of a specific location known for group gatherings, such as a restaurant or a shared workspace. In one or more embodiments, the one or more processors of the electronic device 100 utilize data from the device's location detector, calendar application, and communication circuits to gather these contextual signals.

For instance, the location detector can determine that the electronic device 100 is situated at a known merchant location where group transactions are common. Concurrently, the calendar application may indicate a scheduled event involving multiple participants. Additionally, the communication circuit can detect the presence of other electronic devices within a predefined range, suggesting a group setting. By correlating these signals, the one or more processors can infer the likelihood of a group financial transaction occurring.

Furthermore, the one or more processors can be configured to analyze incoming notifications, such as group messages or event reminders, to identify potential group transactions. The timing of these signals, such as the proximity to a scheduled event or the duration of the devices'co-location, enhances the accuracy of the contextual inference. By integrating these diverse data points, the system reliably identifies scenarios indicative of a probable group electronic financial transaction, thereby enabling the digital wallet application to prepare for an efficient and automated bill-splitting process.

When such a financial transaction is detected, in one or more embodiments an audio input device of the electronic device 100 captures audio input from the environment 200 about the electronic device 100. The audio input device, which may include one or more microphones, captures ambient sounds and voices within the vicinity of the electronic device 100. The captured audio input is then processed by one or more processors of the electronic device 100 to extract relevant audio samples. These audio samples are analyzed to identify one or more participants situated within the environment 200 about the electronic device 100 and participating in the financial transaction.

The one or more processors employ advanced audio processing techniques to isolate and identify distinct voices and sounds from the captured audio input. This may involve filtering out background noise, enhancing voice clarity, and distinguishing between different speakers based on voice characteristics such as pitch, tone, and speech patterns. The one or more processors can compare the extracted audio samples to predefined authentication references stored in the memory of the electronic device 100. These references may include voice samples from previous interactions, voice messages, or manually uploaded voice samples, allowing the system to accurately identify individuals present within the environment.

In scenarios where multiple individuals are present, the one or more processors can distinguish between different voices by analyzing voice characteristics in one or more embodiments. The processors can cross-reference these characteristics with the predefined authentication references to accurately identify each individual person. This capability ensures that the system maintains an up-to-date and accurate list of participants, even in dynamic environments where individuals may join or leave at different times. By capturing and processing audio input in this manner, the system can reliably identify participants involved in the financial transaction, facilitating accurate and efficient bill splitting From these inputs, the one or more processors can automatically present the financial transaction dividing prompt 700. In the illustrative embodiment of FIG. 7, the financial transaction dividing prompt 700 appears after a card payment is successfully processed. In this illustrative embodiment, the financial transaction dividing prompt 700 indicates that a bill split has been identified and provides options for the user to review the bill split and request payment from other participants.

For example, in one or more embodiments the financial transaction dividing prompt 700 includes a message indicating the successful card payment, specifying the amount paid and the merchant's name. The financial transaction dividing prompt 700 also displays a notification that a bill split has been identified, instructing the user to tap to review the bill split and request payment. The prompt provides several user actuation targets, including a “REVIEW SPLIT” button 701, a “RECEIPT” button 702, and a “DISMISS” button 703.

In one or more embodiments, the “REVIEW SPLIT” button 701 allows the user to view the details of the identified bill split and make any necessary adjustments. Said differently, in one or more embodiments the “REVIEW SPLIT” button 701 comprises a user actuation target allowing the one or more participants identified by the financial transaction dividing prompt 700 to be edited.

The “RECEIPT” button 702 provides the user with the option to view or save the transaction receipt. The “DISMISS” button 703 enables the user to close the financial transaction dividing prompt 700 without taking further action. As shown, the financial transaction dividing prompt 700 is designed to facilitate the process of dividing the transaction amount among the participants and requesting reimbursement.

Turning now back to FIG. 2, once the financial transaction dividing prompt (700) has been presented, step 220 comprises performing a reconciliation process to ensure that the list of participants engaged in the financial transaction is accurate. In one or more embodiments, this process can be automatically done at step 220. Illustrating by example, the one or more processors of the electronic device 100 can reconcile calendar events, known devices situated within the environment 200, or the other inputs mentioned above.

Once this list has been compiled, in one or more embodiments the list can be presented to the user for confirmation and/or to allow the user to edit the list. For instance, step 220 can comprise surfacing the “REVIEW SPLIT” button 701 from FIG. 7, while the person 201 can transition the method to step 221 by actuating the “REVIEW SPLIT” button 701. In one or more embodiments, step 222 then comprises accepting user modifications. Step 222 can also comprise fetching contact information, such as an email address or telephone number, for each contact added to the bill division so that notifications to each participant can be sent at step 223.

Other steps can be performed in FIG. 2 to identify which people 201,202,203,204, 205,206 are engaged in the financial transaction and which are not. Illustrating by example, in one or more embodiments the electronic device can capture, with an imager (119) of the electronic device 100, one or more images in response to detecting the financial transaction having the transaction amount.

In one embodiment, the imager (119) captures only a single still image. However, in other embodiments the imager (119) can seamlessly and passively capture more of the scene unfolding in the environment 200 of the electronic device 100 by capturing a plurality of images. Moreover, the one or more processors (106) of the electronic device 100 cause the various sensors of the electronic device to passively capture additional information. As used herein, “passively” means that an operation or action occurs automatically and without an affirmative instruction from a user. Thus, while person 201 has ordered pizza, thereby creating a financial transaction having a transaction amount associated therewith, in one or more embodiments the one or more processors (106) of the electronic device capture additional information from the environment 200 to determine which participants situated within the environment 200 are engaged in the financial transaction. Said differently, the one or more processors (106) of the electronic device 100 can cause the one or more sensors to capture additional information to determine between whom the bill should be split.

Illustrating by example, in a primary embodiment the electronic device 100 captures additional information by receiving, optionally independent of the capture of any image, a predetermined amount of audio input with an audio input/processor (110) from the environment 200 of the electronic device 100. For instance, one or more microphones (113) may capture a predetermined duration, such as three to five seconds of audio input as the predetermined amount of audio input. From this audio input, the one or more processors (106) can extract one or more audio samples identifying one or more participant situated within the environment 200 who are participating in the financial transaction.

Additionally, the electronic device 100 captures information to buttress the audio samples by capturing, with the imager (119) of the electronic device 100, a plurality of images. For instance, in one embodiment the imager (119) can capture three images. It should be noted that three images is one example for the number of images captured. In other embodiments, the plurality of images could be more, or fewer, than three images.

In one or more embodiments, the capture of images and/or audio input can be combined. Illustrating by example, in one or more embodiments, while capturing the three images, a microphone (113) of the electronic device 100 can capture corresponding audio input from the environment 200 about the electronic device 100. This audio, captured during the capture of the three images, can then be synthesized together by the one or more processors (106) of the electronic device to create the predetermined amount of audio input captured from the environment 200 of the electronic device 100.

In still another embodiment, the electronic device 100 captures additional information at by capturing, with the imager (119) of the electronic device 100, a predetermined amount of video input from the environment 200 of the electronic device 100. For instance, the imager (119) may capture a predetermined duration, such as three to five seconds, of video input (as well as the corresponding audio input associated with the video input as the predetermined amount of video input).

The one or more processors (106) of the electronic device can perform analysis operations on the single still image, the predetermined amount of audio content, or the predetermined amount of video content captured as previously described. Illustrating by example, in one or more embodiments one or more sensors (115) of the electronic device 100, in conjunction with the one or more processors (106), identifying one or more of the plurality of persons 202,203,204,205,206 who are participants in the financial transaction. If, for example, person 202 says, “I'm hungry, when is the pizza getting here?” the one or more processors (106) can conclude that person 202 is a participant of the financial transaction.

In one or more embodiments, an audio sensor such as the audio input/processor (110) of the electronic device 100 captures a predetermined amount of audio input. The one or more processors (106) of the electronic device 100 can use this audio input to identify the one or more of the persons 202,203,204,205,206 within the environment 200 of the electronic device 100. When, for example, the audio input includes multiple voices, such as the voice from a man and a voice from a woman, the one or more processors (106) can perform audio processing on the audio input to determine that there are multiple speakers within the environment 200 of the electronic device 100, and therefore, that there are likely to be multiple persons 202, 203,204,205,206 participating in the financial transaction.

The one or more processors (106) identify the persons 202,203,204,205,206 engaged in the financial transaction from the audio samples extracted from the audio input. Illustrating by example, the one or more processors (106) can identify these persons 202,203,204,205,206 using a voice recognition engine incorporated into the audio input/processor (110). The voice recognition engine can comprise executable code, hardware, and various voice print templates (also referred to as “voice models”). The voice recognition engine can use the voice print templates to compare a voiceprint from received input and determine if a match exists. In operation, the voice recognition engine obtains voice data using at least one microphone (113) The voice recognition engine can extract voice recognition features from the voice data and generate a voiceprint. The voice recognition engine can compare the voiceprint to at least one predefined authentication reference, which may comprise a predefined voice print template.

The examples set forth above are merely illustrative of various identification techniques that can be used with electronic devices in accordance with one or more embodiments of the disclosure to identify the persons 202,203,204,205,206 participating in the financial transaction. The identification techniques can be used in alone or in combination. The identification techniques are illustrative only and are not intended to provide a comprehensive list of the techniques for identifying the persons 202,203,204,205,206 engaged in the financial transaction. Numerous others will be obvious to those of ordinary skill in the art having the benefit of this disclosure.

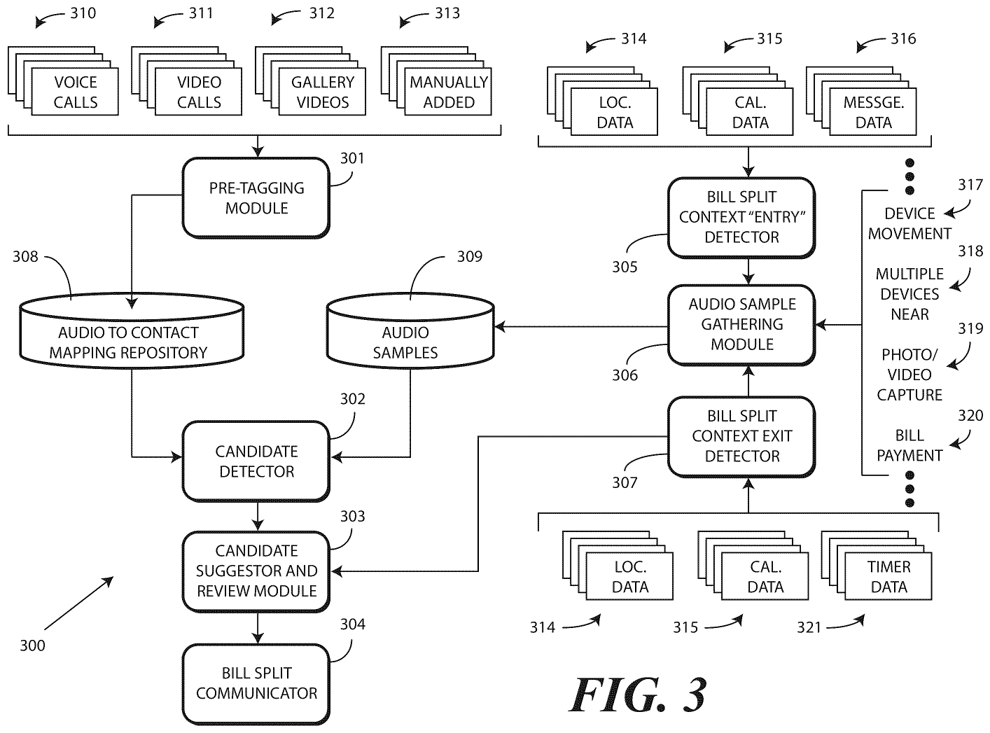

Turning now to FIG. 3, illustrated therein is one explanatory system 300 in accordance with one or more embodiments of the disclosure. FIG. 3 shows an explanatory system 300 for contextually identifying divisions associated with digital transactions. The system 300 comprises a pre-tagging module 301, a candidate detector 302, a candidate suggestion and review module 303, a bill split communicator 304, an audio sample gathering module 306, audio samples, a bill split context exit detector 307, an audio contact mapping repository 308, and various data sources including voice calls 310, video calls 311, gallery videos 312, manually added audio samples 313, location data 314, calendar data 315, message data 316, device movement data 317, and multiple devices near data 318.

In one or more embodiments, the pre-tagging module 301 processes incoming data to pre-tag potential candidates for bill splitting. Illustrating by example, the pre-tagging module 301 can look at various different signals across the device to populate a “contact detection based upon audio” database, which is stored in the audio to contact mapping repository 308. Examples of such signals include audio from voice calls 310, video calls 311, or gallery videos 312. Of course, audio samples 313 can be manually added as well.

The pre-tagging module 301 interacts with the audio contact mapping repository 308 to map audio samples to contact information. The audio contact mapping repository 308 stores mappings between audio samples and contact information, facilitating the identification of participants in a financial transaction.

The candidate detector 302 receives audio samples and utilizes the mappings from the audio contact mapping repository 308 to detect potential candidates for bill splitting. In one or more embodiments, the candidate detector 302 compares the pre-tagged database and the samples gathered to identify known contacts. In one or more embodiments, the candidate detector 302 sends the detected candidates to the candidate suggestion and review module 303 for further processing.

In one or more embodiments, the candidate suggestion and review module 303 processes the detected candidates and suggests potential participants for the bill split. In one or more embodiments, the candidate suggestion and review module 303 presents all the identified candidates to the user and allows him/her to modify as appropriate including the share percentages.

The candidate suggestion and review module 303 allows for user review and modification of the suggested participants before finalizing the bill split. The bill split communicator 304 then communicates the finalized bill split information to the relevant participants.

The audio sample gathering module 306 captures audio samples from the environment. The audio sample gathering module 306 interacts with the bill split context exit detector 307 to determine the context of the captured audio samples.

In one or more embodiments, the audio sample gathering module 306 looks for further fine contexts to determine when to take audio samples and then writes the captured samples to the audio samples database 309. Illustrating by example, the audio sample gathering module 306 can consider device movement data 317, whether multiple device data 318 are nearby, photos and videos 319 captured from the environment of the electronic device, and financial transaction completion data 320 to better identify the participants who may be engaged in the financial transaction.

The bill split context entry detector 305 looks at a variety of contexts to determine if the device has to start actively looking for bill split candidates. To do this, in one or more embodiments the bill split context entry detector 305 uses various data sources, including location data 314, calendar data 315, and message data 316 to assess the context of the financial transaction.

The bill split context exit detector 307 actively looks to see when the device can stop looking for bill split candidates. Once the bill split context exit detector 307 detects a cessation of searching for candidates, in one or more embodiments the bill split context exit detector 307 can alert the audio sample gathering module 306 as well as the review module. In one or more embodiments, the bill split context exit detector 307 looks at a variety of contexts to determine if the device can stop actively looking for bill split candidates. To do this, in one or more embodiments the bill split context exit detector 307 uses various data sources, including location data 314, calendar data 315, and timer data 321 to assess the context of the financial transaction.

Once confirmed by a user, the bill split communicator 304 can transmit messages to all participants engaged in the financial transaction. In one or more embodiments, the communications transmitted by the bill split communicator 304 can include the amount owed by each participant.

The system 300 also includes various data sources that provide additional context for the financial transaction. These data sources include voice calls 310, video calls 311, gallery videos 312, manually added audio samples 313, location data 314, calendar data 315, message data 316, device movement data 317, and multiple devices near data 318. These data sources help the system 300 to accurately identify participants and context for the bill split.

The bill split context exit detector 307 uses the data from these sources to determine the context of the financial transaction. The bill split context exit detector 307 sends this context information to the audio sample gathering module 306, which captures relevant audio samples. The audio samples are then processed by the candidate detector 302 and the candidate suggestion and review module 303 to identify and suggest participants for the bill split.

The system 300 ensures accurate and efficient identification of participants in a financial transaction by leveraging various data sources and advanced audio processing techniques. The system 300 dynamically adapts to the context of the transaction, ensuring that the bill is split among the correct participants.

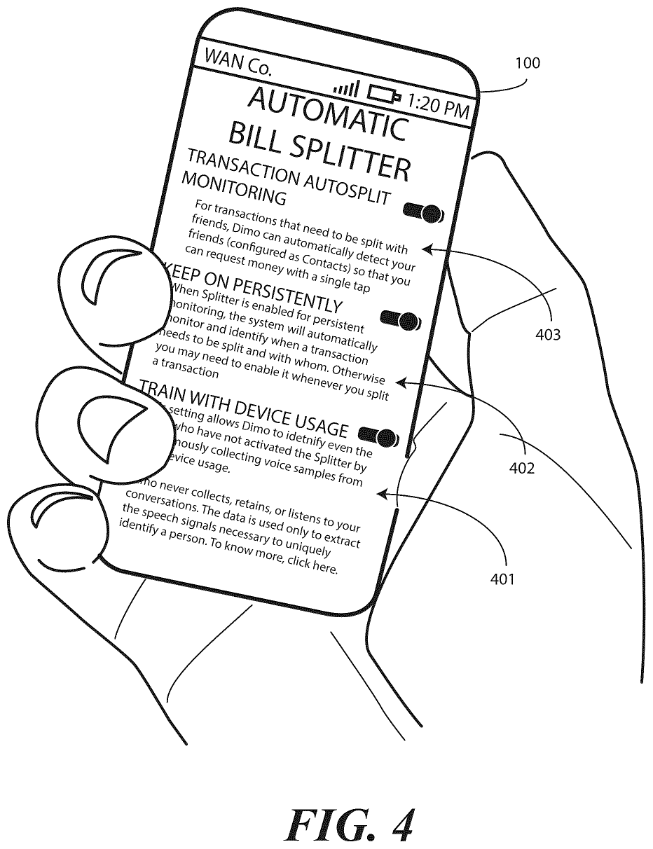

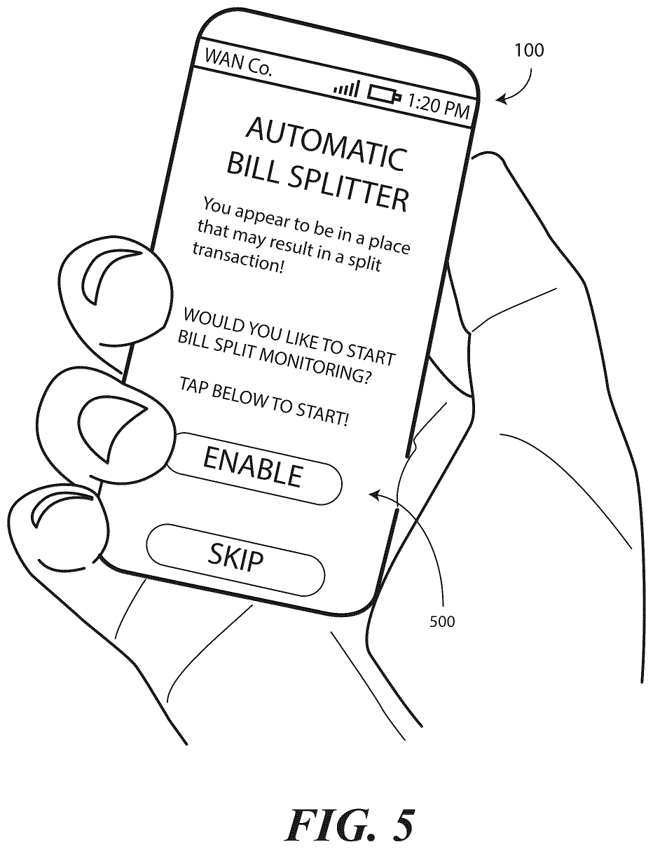

Embodiments of the disclosure contemplate that a user may want to selectively actuate the system 300 of FIG. 3. In one or more embodiments, the user can do this by navigating user settings or controls. Turning now to FIGS. 4-5, illustrated therein is one explanatory user interface 500 illustrating how this can occur.

FIG. 4 shows an electronic device 100 displaying a user interface 401 for enabling bill split monitoring functionality. The user interface 401 presents options for automatic bill splitting, transaction autosplit monitoring, and training with device usage. The user interface 401 is designed to facilitate the process of dividing transaction amounts among participants and requesting reimbursement.

The user interface 401 includes a transaction autosplit monitoring option 402. The transaction autosplit monitoring option 402 allows the user to enable automatic detection of transactions that need to be split with friends. This option configures the system to automatically detect and request splits with a single tap, simplifying the process for the user.

The user interface 401 also includes a keep on persistently option 403. The keep on persistently option 403 enables the system to maintain persistent monitoring for transactions that need to be split. When this option is enabled, the system will automatically detect and split transactions without requiring manual intervention from the user, ensuring continuous and seamless operation.

The user interface 401 further includes a train with device usage option 404. The train with device usage option 404 allows the system to identify participants even if they have not actively engaged with the device. This option uses previously collected voice samples from device usage to accurately identify participants, enhancing the system's ability to detect and split transactions among the correct individuals.

FIG. 5 shows an electronic device 100 displaying a user interface 500 for enabling bill split monitoring functionality. The user interface 500 presents an option to start bill split monitoring in response to detecting a context that may result in a split transaction.

The electronic device 100 includes a display that shows a prompt indicating the potential for a split transaction. The prompt on the user interface 500 reads “AUTOMATIC BILL SPLITTER” and informs the user that they appear to be in a place that may result in a split transaction. The prompt further asks if the user would like to start bill split monitoring and provides instructions to tap below to start.

The user interface 500 includes two user actuation targets: an “ENABLE” button and a “SKIP” button. The “ENABLE” button allows the user to start the bill split monitoring process, while the “SKIP” button allows the user to dismiss the prompt without enabling the monitoring feature. The user can interact with these buttons to control the bill split monitoring functionality of the electronic device 100.

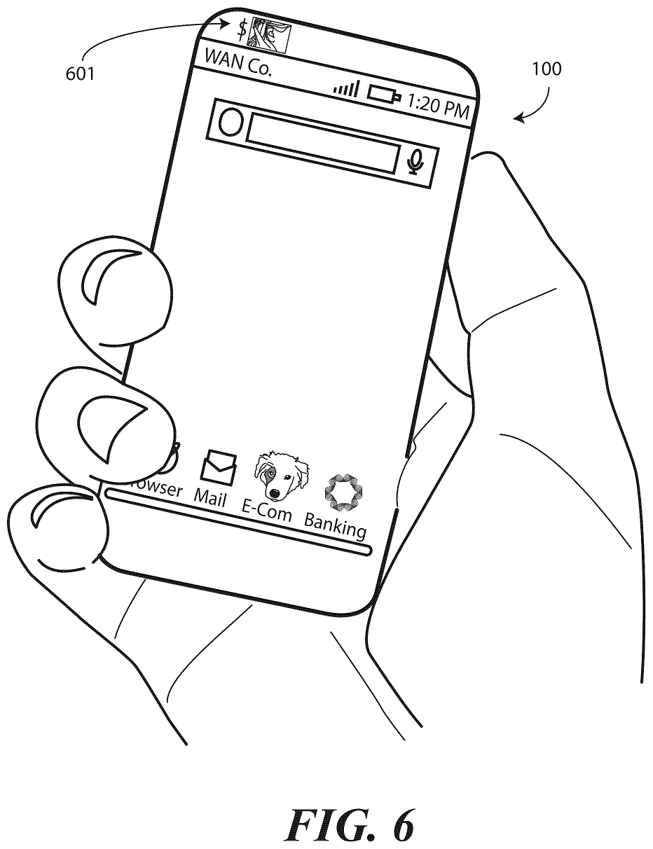

Turning now to FIG. 6, in one or more embodiments an icon 601 is presented whenever the electronic device 100 is capturing audio from the environment. Embodiments of the disclosure contemplate that there are privacy concerns that can be associated with audio capture. For this reason, embodiments of the disclosure seen not only to limit the capture of audio, but to alert users regarding when audio is captured as well.

In one or more embodiments, the icon 601 in FIG. 6 serves as a visual indicator to inform the user whether the audio for the bill split feature is being captured. This icon 601 provides a clear and immediate indication of the system's operational status, thereby ensuring user awareness and maintaining privacy. When the system detects a financial transaction and initiates the audio capture process to identify bill split candidates, the icon 601 becomes active, signaling to the user that audio data is being recorded. This activation of the icon 601 ensures that the user is fully aware of the ongoing audio capture, thereby addressing any privacy concerns.

When the audio capture process is not active, the icon 601 remains inactive or changes the state of the icon 601 to indicate that no audio is being recorded. This dual-state functionality of the icon 601 provides a straightforward and transparent method for users to understand when their audio environment is being monitored and when the audio environment is not being monitored. By providing this real-time feedback, the icon 601 enhances user trust and confidence in the system, ensuring that users are informed about the status of audio capture related to the bill split feature.

Embodiments of the disclosure also work to limit the amount that audio is stored. Illustrating by example, in one or more embodiments the one or more processors (106) of the electronic device 100 delete, from a memory associated with the electronic device 100, the one or more audio samples captured while the icon 601 is present that identify the one or more participants situated within the environment about the electronic device 100 who are participating in the financial transaction. In one or more embodiments, this deletion occurs after causing the communication device of the electronic device 100 has transmitted the one or more financial transaction portion reimbursement messages.

Thus, in one or more embodiments the one or more processors (106) of the electronic device 100 detect a financial transaction having a transaction amount using a digital wallet application operable on the one or more processors (106) of the electronic device 100. An audio input device of the electronic device 100 can capture audio input from an environment about the electronic device 100.

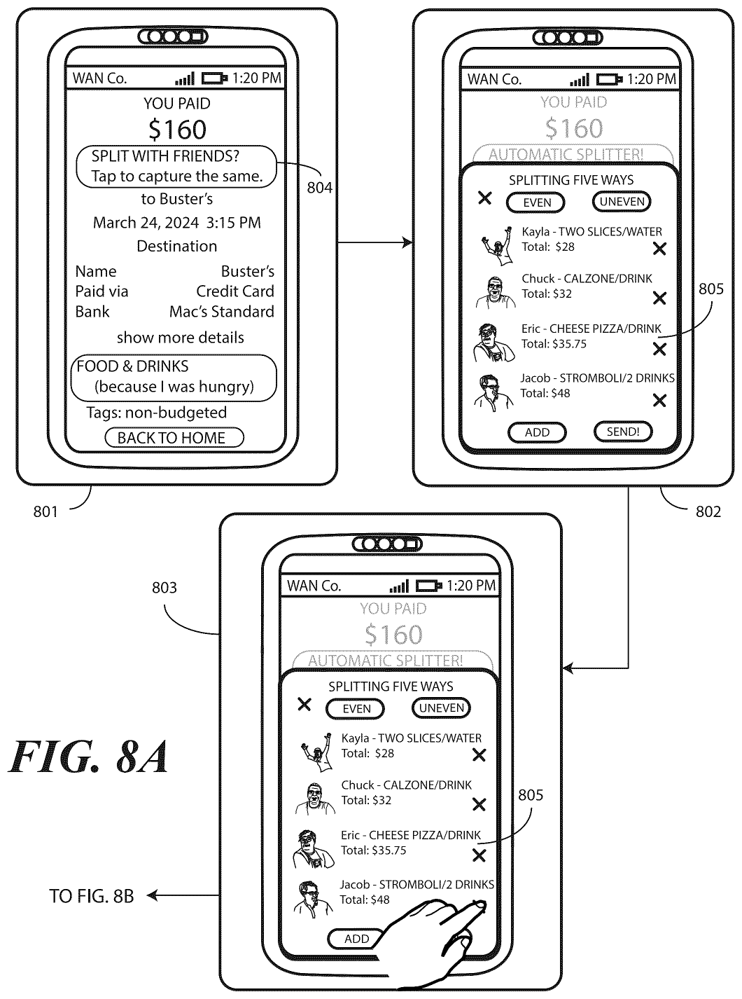

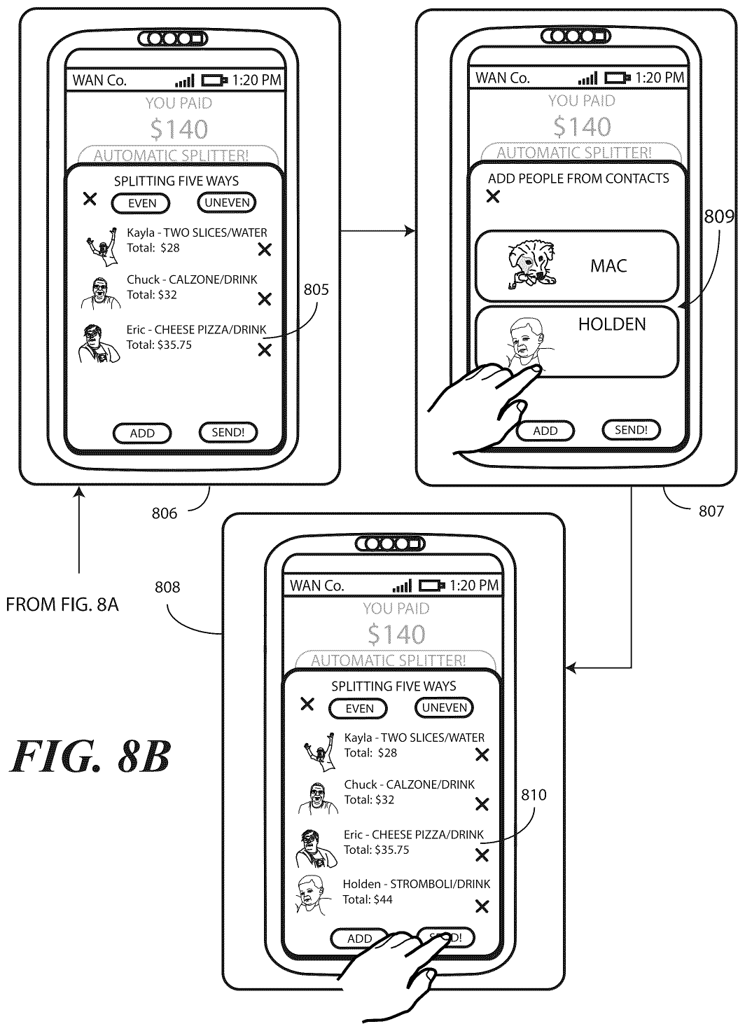

The one or more processors (106) of the electronic device 100 can capture one or more audio samples identifying one or more participants who are situated within the environment about the electronic device 100 and participating in the financial transaction. The one or more processors (106) can also automatically present, on a user interface of the electronic device 100, a financial transaction dividing prompt. As will be shown below in FIGS. 8A and 8B, in one or more embodiments the financial transaction dividing prompt identifies the one or more participants participating in the financial transaction and a corresponding portion of the transaction amount assigned to each participant of the one or more participants.

In one or more embodiments, the financial transaction dividing prompt comprises one or more user actuation targets allowing the transaction amount to be split evenly or unevenly among the one or more participants participating in the financial transaction. The financial transaction dividing prompt can further comprise one or more other user actuation targets allowing the one or more participants identified by the prompt to be edited. The financial transaction dividing prompt can further comprise one or more other user actuation targets that, when actuated, cause a communication device of the electronic device to transmit one or more financial transaction portion reimbursement messages to one or more remote electronic devices belonging to the one or more participants participating in the financial transaction.

In one or more embodiments, the one or more processors (106) delete, from a memory associated with the electronic device 100, the one or more audio samples identifying the one or more participants situated within the environment about the electronic device 100 and participating in the financial transaction after causing the communication device of the electronic device 100 to transmit the one or more financial transaction portion reimbursement messages. This deletion process ensures that the audio samples are not retained longer than necessary, thereby addressing potential privacy concerns associated with the capture and storage of audio data. The deletion of audio samples ensures that once the financial transaction portion reimbursement messages have been sent, the audio samples are promptly removed from the memory, maintaining user privacy and data security.

Now that the elements of electronic devices, systems, and methods have been described, attention will be turned to a particular use case shown in FIGS. 8A-8B to further illustrate aspects, benefits, and advantages offered by embodiments of the disclosure.

Beginning with FIG. 8A, illustrated therein are one or more method steps 801,802,803 in accordance with one or more embodiments of the disclosure. Step 801 of FIG. 8A illustrates a user interface presented once a financial transaction having a transaction amount has been detected.

In one or more embodiments, the user interface includes a financial transaction dividing initiation prompt 804, which can be actuated to identify one or more participants participating in the financial transaction identified by the user interface. In this illustrative example, the financial transaction dividing initiation prompt 804 is presented, by the one or more processors on the user interface of the electronic device, concurrently with details of the financial transaction.

In one or more embodiments, the financial transaction dividing initiation prompt 804 allows a user to initiate the automatic processes of capturing, with an audio input device of the electronic device, audio input from an environment about the electronic device, extracting, by the one or more processors of the electronic device, one or more audio samples identifying one or more participants situated within the environment about the electronic device and participating in the financial transaction, and automatically presenting, by the one or more processors on a user interface of the electronic device, a financial transaction dividing prompt 805 at step 802 identifying the one or more participants participating in the financial transaction and a corresponding portion of the transaction amount assigned to each participant of the one or more participants.

In one or more embodiments, the user interface presented with the financial transaction dividing initiation prompt 804 provides a clear and concise summary of the detected financial transaction, including the transaction amount and the merchant's name. In one or more embodiments, the financial transaction dividing initiation prompt 804 serves as an initial notification to the user that a bill-splitting scenario has been identified and requires further action. While a user can initiate the bill splitting process by actuating the financial transaction dividing initiation prompt 804 in one or more embodiments, in other embodiments this bill splitting system will launch automatically in response to the detection of the financial transaction with the transaction amount associated therewith in the digital wallet application operating on the one or more processors of the electronic device. Whether automatic or manual via actuation of the financial transaction dividing initiation prompt 804 can be defined in the user settings in one or more embodiments.

Once the automatic processes of capturing, with an audio input device of the electronic device, audio input from an environment about the electronic device the extracting, by the one or more processors of the electronic device, one or more audio samples identifying one or more participants situated within the environment about the electronic device and participating in the financial transaction is complete, step 802 comprises automatically presenting, by the one or more processors on a user interface of the electronic device, a financial transaction dividing prompt 805.

As shown at step 802, in one or more embodiments the financial transaction dividing prompt 805 identifies the one or more participants participating in the financial transaction. In this illustrative embodiment, the financial transaction dividing prompt 805 also includes a corresponding portion of the transaction amount assigned to each participant of the one or more participants. The financial transaction dividing prompt 805 is further presented concurrently with details of the financial transaction as shown at step 802 in this illustrative embodiment.

Shown at the top of the financial transaction dividing prompt 805, in one or more embodiments the financial transaction dividing prompt 805 comprises one or more user actuation targets allowing the transaction amount to be split evenly or unevenly among the one or more participants participating in the financial transaction. Illustrating by example, the financial transaction dividing prompt 805 of step 802 includes an “even” user actuation target and an “uneven”user actuation target situated toward the top of the prompt.

In one or more embodiments, actuating the even user actuation target in the financial transaction dividing prompt 805 of step 802 will cause the transaction amount of the financial transaction to be split evenly across the participants in the financial transaction. This action ensures that each participant is assigned an equal portion of the total transaction amount, simplifying the process of bill splitting when all participants have contributed equally to, or agreed equally to divide, the shared expense. The even user actuation target provides a straightforward method for dividing the bill, reducing the need for manual calculations and minimizing the potential for errors.

Conversely, actuating the uneven user actuation target allows the bill to be split unevenly. This functionality is particularly useful in scenarios where participants have contributed different amounts to the shared expense.

For instance, when separate amounts are received from a merchant point of sale terminal, the uneven user actuation target enables the system to allocate the correct portion of the transaction amount to each participant based on the individual amounts recorded at the point of sale. Additionally, the uneven user actuation target allows for manual editing by a user, providing the flexibility to adjust the amounts assigned to each participant as needed. This feature accommodates various real-world situations where contributions may not be equal, ensuring that the bill is divided accurately and fairly among all participants.

Having both options available in the financial transaction dividing prompt 805 enhances the versatility and usability of the system. Users can choose the even split option for simplicity and efficiency when contributions are equal or opt for the uneven split option to accurately reflect varying contributions. This dual functionality ensures that the system can handle a wide range of bill-splitting scenarios, providing users with the flexibility to manage shared expenses in a manner that suits their specific needs.

In this illustrative example, the financial transaction dividing prompt 805 of step 802 initially detected five participants, which include the user of the electronic device and the four people listed in the financial transaction dividing prompt 805, namely Kayla, Chuck, Eric, and Jacob. The detection process involved capturing audio input from the environment about the electronic device and extracting audio samples to identify the participants. The system then cross-referenced these audio samples with predefined authentication references stored in the memory of the electronic device to accurately identify each individual present during the financial transaction.

Once the participants were identified, the financial transaction dividing prompt 805 displayed the names of the user and the four other participants. In one or more embodiments, the system can also detect the details of the financial transaction by accessing the receipt automatically from user device or through manual input by the user. Additionally, system can also cross reference the same against the various captured audio samples to infer the items ordered by each of the identified user. In this example, the merchant point of sale terminal transmitted a receipt of the financial transaction to a communication device of the electronic device, detailing the items each person had and their respective costs.

In this illustrative embodiment, the receipt indicates that the user had a main course and a beverage totaling $16.25. The first participant, Kayla, had a two slices of Buster's finest pizza and water, totaling $28.00. The second participant, Chuck, had a calzone and a soft drink totaling $32.00. The third participant, Eric, had a cheese pizza and a drink, totaling $35.75. The fourth participant, Jacob, had a stromboli and two drinks, totaling $48.00. In one or more embodiments, when the receipt of financial transaction is received, the one or more processors can automatically populate the even or uneven breakdown without associating the items ordered by each individual. In other embodiments, where the receipt identifies the participants, each individual's specific charge can be assigned to that person. Other techniques for using information taken from the receipt will be obvious to those of ordinary skill in the art having the benefit of this disclosure.

The financial transaction dividing prompt 805 automatically calculated each participant's share based on the receipt details. The user interface presented the total amount of the transaction and the individual shares assigned to each participant. The user could review the suggested shares and make any necessary adjustments before sending payment requests to the other participants. This automated process ensured accurate and efficient bill splitting, reducing the likelihood of errors and minimizing the burden on the user.

In one or more embodiments, the automatic presentation of the financial transaction dividing prompt 805 identifying the one or more participants participating in the financial transaction and the corresponding portion of the transaction amount assigned to the each participant of the one or more participants is only presented in response to the one or more processors detecting a shared financial transaction trigger. The shared financial transaction trigger can vary.

In one or more embodiments, the shared financial transaction trigger comprises a calendaring event stored in a calendaring application operating on the one or more processors that identifies a merchant. In one or more embodiments, the calendaring event serves as a contextual signal indicating a probable group electronic financial transaction.

For instance, when a user schedules a dinner reservation at a restaurant using the calendaring application, the event details may include the restaurant's name, location, and the time of the reservation. This information is stored in the calendaring application and can be accessed by the one or more processors to identify the merchant associated with the scheduled event.

Upon detecting the calendaring event, the one or more processors can infer that a group financial transaction is likely to occur at the specified time and location. This inference is based on the contextual information provided by the calendaring event, such as the presence of a merchant's name and the nature of the event (e.g., a dinner reservation). The system can then prepare to capture audio samples and identify participants during the event, facilitating an automated bill-splitting process once the financial transaction occurs.

If, for example, a user schedules a birthday party at a local café using the calendaring application, the event details may include the café's name, address, and the time of the party. The one or more processors can access this information and recognize the café as a merchant where a group financial transaction is likely to take place. As the event approaches, the system can activate the audio input device to capture audio samples from the environment, identifying the participants present at the café. Once the financial transaction is detected, the system can automatically present a financial transaction dividing prompt, allowing the user to review and confirm the identified participants and their respective shares of the transaction amount.

In another scenario, a user may schedule a team lunch at a popular restaurant using the calendaring application. The event details, including the restaurant's name and the time of the lunch, are stored in the calendaring application. The one or more processors can access this information and determine that a group financial transaction is likely to occur at the restaurant. As the scheduled time approaches, the system can activate the audio input device to capture audio samples, identifying the team members present at the lunch. When the financial transaction is detected, the system can present a financial transaction dividing prompt, allowing the user to confirm the participants and send payment requests to the team members.

In another embodiment, the shared financial transaction trigger comprises actuation of a user actuation target presented in another prompt presented in response to the one or more processors. Illustrating by example, if the user actuates the financial transaction dividing initiation prompt 804 at step 801, in one or more embodiments this constitutes a shared financial transaction trigger. In one or more embodiments, when this occurs, the electronic device uses one or more sensors of the electronic device to identify a financial transaction context within the environment of the electronic device.

For instance, when the electronic device detects that the electronic device is situated at a restaurant, the one or more processors may present a prompt on the user interface asking if the user would like to enable bill split monitoring. Said differently, in one or more embodiments the shared financial transaction trigger comprises a location detector of the electronic device determining the electronic device is situated at a merchant location.

This prompt can be triggered by the location detector identifying the restaurant's location and the communication circuit detecting multiple electronic devices in close proximity, suggesting a group setting. The user can then actuate the financial transaction dividing initiation prompt 804, which is configured as a user actuation target, within the user interface of step 801 to initiate the bill split monitoring process.

Another example involves the electronic device detecting a calendar event indicating a group activity, such as a scheduled dinner or a team outing. The one or more processors can present a prompt on the user interface, asking if the user would like to enable bill split monitoring for the upcoming event. This prompt can be triggered by the calendar application identifying the event details and the location detector confirming the user's presence at the event location. The user can then actuate the user actuation target within the prompt to start the bill split monitoring process, allowing the system to capture audio samples and identify participants during the event.

In a further example, the electronic device may detect an incoming group message or event reminder indicating a potential group financial transaction. The one or more processors can present a prompt on the user interface, asking if the user would like to enable bill split monitoring based on the context of the group message. This prompt can be triggered by the messaging application identifying the group message and the communication circuit detecting multiple electronic devices in the vicinity. The user can then actuate the user actuation target within the prompt to initiate the bill split monitoring process, ensuring accurate identification of participants and efficient bill splitting.

In reviewing the participants, the user of the electronic device has noticed that Jacob has been incorrectly identified. Accordingly, embodiments of the disclosure allow the financial transaction dividing prompt 805 to be edited. As shown at step 803, the user delivers user input to the financial transaction dividing prompt 805 to delete Jacob.

The user could equally deliver other user input to the financial transaction dividing prompt 805 to change the amounts allocated to each participant as well. Said differently, in one or more embodiments the user input delivered at step 802 could be used to alter the financial transaction portion amount attributed to the each individual of the plurality of individuals by an amount defined by the user input.

Turning now to FIG. 8B, as shown at step 806 Jacob has been removed from the financial transaction dividing prompt 805. In one or more embodiments, the user then delivers user input to actuate the “add” user actuation target presented in the financial transaction dividing prompt 805, which moves the method steps to step 807. As shown, people from the contacts list have been presented. The user can scroll through the contacts to add a participant. In this example, the user has selected Holden at step 807. This results in a modified financial transaction dividing prompt 810 being presented at step 808.

Since the participants are now correct, the user can deliver user input to the “send” user actuation target of the modified financial transaction dividing prompt 810 at step 808. When actuated, the send user actuation target causes a communication device of the electronic device to transmit one or more financial transaction portion reimbursement messages to one or more remote electronic devices belonging to the one or more participants participating in the financial transaction.

Once the proper participants are confirmed at step 808, in one or more embodiments the one or more processors further are configured to cause the audio input device to cease capturing the one or more audio signals. In other embodiments, this cessation can occur in response to the presentation of the prompt at step (802) of FIG. 8A. In one or more embodiments, the one or more processors then delete the one or more audio signals from the memory in response to the communication device transmitting the plurality of financial transaction portion reimbursement messages at step 808 in response to the send user actuation target.

Thus, in one or more embodiments the financial transaction dividing prompt 805 comprises one or more other user actuation targets that, when actuated, cause a communication device of the electronic device to transmit one or more financial transaction portion reimbursement messages to one or more remote electronic devices belonging to the one or more participants participating in the financial transaction. Illustrating by example, the modified financial transaction dividing prompt 810 of step 808 comprises a “send” user actuation target situated toward the bottom of the modified financial transaction dividing prompt 810.

The cessation of capture of the audio samples, deletion of the audio samples, and transmission of the messages can be automatic as well. Illustrating by example, in one or more embodiments the capturing, with the audio input device of the electronic device, the audio input from an environment about the electronic device occurs for less than a predefined duration from the detecting, with the one or more processors of the electronic device, the financial transaction using the digital wallet application operable on the one or more processors of the electronic device. Similarly, in one or more embodiments when a location detector of the electronic device detects the electronic device exiting a location region associated with the financial transaction, the one or more processors can delete, from a memory associated with the electronic device, the one or more audio samples identifying the one or more participants situated within the environment about the electronic device and participating in the financial transaction after causing a communication device of the electronic device to transmit one or more financial transaction portion reimbursement messages. Thereafter the one or more processors can deactivate the audio input device.

As illustrated and described a method in an electronic device comprises detecting, with one or more processors of the electronic device, a financial transaction having a transaction amount using a digital wallet application operable on the one or more processors of the electronic device. The method further comprises capturing, with an audio input device of the electronic device, audio input from an environment about the electronic device.

In one or more embodiments, the method comprises extracting, by the one or more processors of the electronic device, one or more audio samples identifying one or more participants situated within the environment about the electronic device and participating in the financial transaction. In one or more embodiments, the method comprises automatically presenting, by the one or more processors on a user interface of the electronic device, a financial transaction dividing prompt identifying the one or more participants participating in the financial transaction and a corresponding portion of the transaction amount assigned to each participant of the one or more participants.

In some embodiments, the electronic device is configured to detect a financial transaction using a digital wallet application by monitoring transaction-related events generated within the application. These events include data packets containing transaction details such as the transaction amount, merchant information, and timestamp.

The device's processors can continuously or periodically scan the application's event logs or transaction history to identify these events. Upon detecting a transaction event, the processors extract relevant details and capture audio input from the environment using an audio input device, such as one or more microphones. The captured audio is then processed to extract audio samples that identify participants in the transaction.

In one or more embodiments, the system employs advanced audio processing techniques to isolate distinct voices and compare them to predefined authentication references stored in the device's memory, ensuring accurate identification of participants. In another embodiment, the system can be configured to detect contextual signals indicative of a probable group transaction, such as the presence of multiple electronic devices in close proximity, calendar events indicating group activities, or specific locations known for group gatherings.

The system can then capture audio samples in response to these contextual signals. Additionally, the system can present a financial transaction dividing prompt on the user interface, allowing the user to review and confirm the identified participants and their respective shares of the transaction amount. The prompt can include user actuation targets for splitting the transaction amount evenly or unevenly among participants and for editing the list of participants. In yet another embodiment, the system can automatically cease capturing audio and delete the audio samples from memory after the financial transaction portion reimbursement messages have been transmitted to the participants, ensuring user privacy and data security. This adaptability allows the system to function effectively in various real-world scenarios, such as group dining, team outings, or shared expenses, providing a flexible and automated approach to bill splitting.

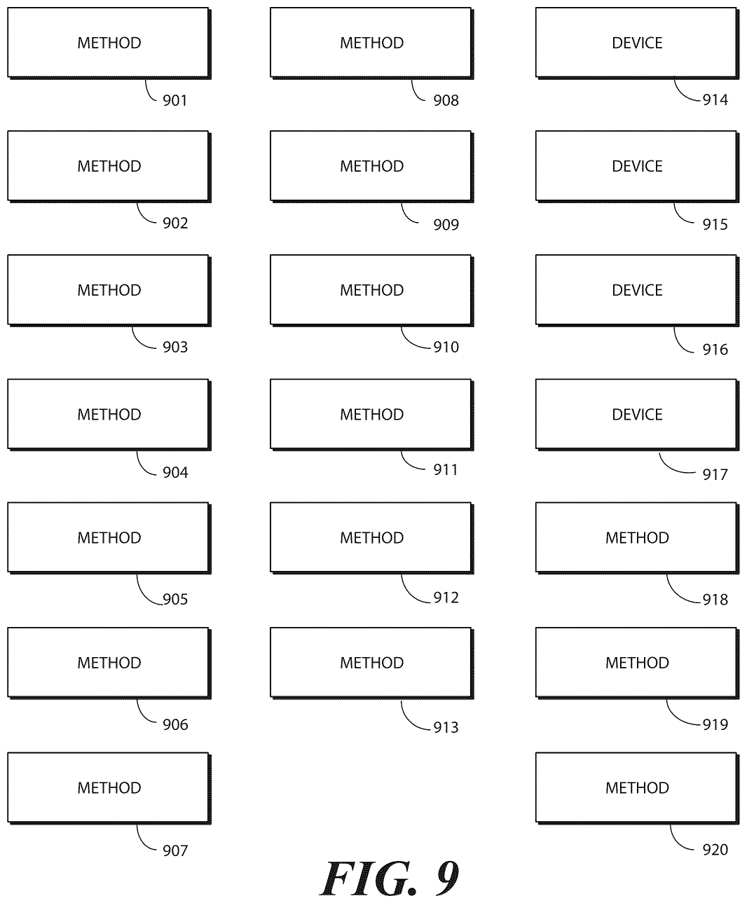

Turning now to FIG. 9, illustrated therein are various embodiments of the disclosure. The embodiments of FIG. 9 are shown as labeled boxes in FIG. 9 due to the fact that the individual components of these embodiments have been illustrated in detail in FIGS. 1-8, which precede FIG. 9. Accordingly, since these items have previously been illustrated and described, their repeated illustration is no longer essential for a proper understanding of these embodiments. Thus, the embodiments are shown as labeled boxes.

At 901, a method in an electronic device comprises detecting, with one or more processors of the electronic device, a financial transaction having a transaction amount using a digital wallet application operable on the one or more processors of the electronic device. At 901, the method comprises capturing, with an audio input device of the electronic device, audio input from an environment about the electronic device/.

At 901, the method comprises extracting, by the one or more processors of the electronic device, one or more audio samples identifying one or more participants situated within the environment about the electronic device and participating in the financial transaction. At 901, the method comprises automatically presenting, by the one or more processors on a user interface of the electronic device, a financial transaction dividing prompt identifying the one or more participants participating in the financial transaction and a corresponding portion of the transaction amount assigned to each participant of the one or more participants.

At 902, the financial transaction dividing prompt of 901 comprises one or more user actuation targets allowing the transaction amount to be split evenly or unevenly among the one or more participants participating in the financial transaction. At 903, the financial transaction dividing prompt of 902 further comprises one or more other user actuation targets allowing the one or more participants identified by the prompt to be edited.

At 904, the financial transaction dividing prompt of 902 further comprises one or more other user actuation targets that, when actuated, cause a communication device of the electronic device to transmit one or more financial transaction portion reimbursement messages to one or more remote electronic devices belonging to the one or more participants participating in the financial transaction. At 905, the method of 904 further comprises deleting, by the one or more processors from a memory associated with the electronic device, the one or more audio samples identifying the one or more participants situated within the environment about the electronic device and participating in the financial transaction after causing the communication device of the electronic device to transmit the one or more financial transaction portion reimbursement messages.

At 906, the automatic presenting of 901 of the financial transaction dividing prompt identifying the one or more participants participating in the financial transaction and the corresponding portion of the transaction amount assigned to the each participant of the one or more participants is only presented in response to the one or more processors detecting a shared financial transaction trigger. At 907, the shared financial transaction trigger of 906 comprises a calendaring event stored in a calendaring application operating on the one or more processors that identifies a merchant.

At 908, the shared financial transaction trigger of 906 comprises actuation of a user actuation target presented in another prompt presented in response to the one or more processors, using one or more sensors of the electronic device, identifying a financial transaction context within the environment of the electronic device. At 909, the shared financial transaction trigger of 906 comprises a location detector of the electronic device determining the electronic device is situated at a merchant location. At 910, the shared financial transaction trigger of 909 further comprises a communication device of the electronic device determining that multiple electronic devices are situated at the merchant location.

At 911, the method of 901 further comprises detecting, with a location detector of the electronic device, the electronic device exiting a location region associated with the financial transaction. At 911, the method comprises deleting, by the one or more processors from a memory associated with the electronic device, the one or more audio samples identifying the one or more participants situated within the environment about the electronic device and participating in the financial transaction after causing a communication device of the electronic device to transmit one or more financial transaction portion reimbursement messages. At 911, the method comprises deactivating, by the one or more processors, the audio input device.

At 912, the capturing of 901, with the audio input device of the electronic device, the audio input from an environment about the electronic device occurs for less than a predefined duration from the detecting, with the one or more processors of the electronic device, the financial transaction using the digital wallet application operable on the one or more processors of the electronic device. At 913, the prompt of 901 is presented, by the one or more processors on the user interface of the electronic device, concurrently with details of the financial transaction.

At 914, an electronic device comprises a user interface, an audio input device, and one or more processors operable with the user interface and the audio input device and operating a digital wallet application. At 914, the one or more processors are configured to determine, from one or more audio signals captured by the audio input device, a plurality of individuals participating in a financial transaction executed by the digital wallet application and, in response, to present a prompt identifying both the plurality of individuals and a financial transaction portion amount attributed to each individual of the plurality of individuals. At 914, the prompt allows user input received by the user interface to manipulate the financial transaction portion amount attributed to the each individual of the plurality of individuals.

At 915, the one or more processors of 914, in response to the user input, alter the financial transaction portion amount attributed to the each individual of the plurality of individuals by an amount defined by the user input. At 916, the electronic device of 915 further comprises a communication device operable with the one or more processors. At 916, the prompt comprises a financial transaction portion reimbursement message transmission user actuation target. At 916, the one or more processors, in response to actuation of the financial transaction portion reimbursement message transmission user actuation target, cause the communication device to transmit a plurality of financial transaction portion reimbursement messages to a plurality of remote electronic devices belonging to the plurality of individuals.

At 917, the electronic device of 916 further comprises a memory operable with the one or more processors. At 917, the one or more processors further are configured to cause the audio input device to cease capturing the one or more audio signals in response to the presentation of the prompt and to delete the one or more audio signals from the memory in response to the communication device transmitting the plurality of financial transaction portion reimbursement messages.

At 918, a method in an electronic device comprises identifying, by one or more processors of the electronic device, one or more contextual signals indicative of a probable group electronic financial transaction occurring in a digital wallet application operating on the one or more processors. At 918, the method comprises capturing, by an audio input device in response to the one or more contextual signals, audio samples from an environment of the electronic device.

At 918, the method comprises identifying, by the one or more processors from the audio samples, a group of individuals participating in the probable group electronic financial transaction. At 918, the method comprises detecting, by the one or more processors from the digital wallet application, an actual financial transaction occurring. At 918, the method comprises presenting, by the one or more processors prior to completion of the actual financial transaction, a prompt identifying the group of individuals and facilitating a division of a transaction amount associated with the actual financial transaction into portions allocated to each individual associated with the group of individuals.

At 919, the method of 918 further comprises ceasing, by the audio input device, the capturing of the audio samples upon the one or more processors presenting the prompt. At 920, the identifying of 918 of the group of individuals participating in the probable group electronic financial transaction comprises comparing the audio samples to one or more of previously captured voice call audio signals, previously captured video call audio signals, previously captured videos, or previously manually stored audio samples.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. A method in an electronic device, the method comprising:
detecting, with one or more processors of the electronic device, a financial transaction having a transaction amount using a digital wallet application operable on the one or more processors of the electronic device;
capturing, with an audio input device of the electronic device, audio input from an environment about the electronic device;
extracting, by the one or more processors of the electronic device, one or more audio samples identifying one or more participants situated within the environment about the electronic device and participating in the financial transaction; and
automatically presenting, by the one or more processors on a user interface of the electronic device, a financial transaction dividing prompt identifying the one or more participants participating in the financial transaction and a corresponding portion of the transaction amount assigned to each participant of the one or more participants.

2. The method of claim 1, wherein the financial transaction dividing prompt comprises one or more user actuation targets allowing the transaction amount to be split evenly or unevenly among the one or more participants participating in the financial transaction.

3. The method of claim 2, wherein the financial transaction dividing prompt further comprises one or more other user actuation targets allowing the one or more participants identified by the financial transaction dividing prompt to be edited.

4. The method of claim 2, wherein the financial transaction dividing prompt further comprises one or more other user actuation targets that, when actuated, cause a communication device of the electronic device to transmit one or more financial transaction portion reimbursement messages to one or more remote electronic devices belonging to the one or more participants participating in the financial transaction.

5. The method of claim 4, further comprising deleting, by the one or more processors from a memory associated with the electronic device, the one or more audio samples identifying the one or more participants situated within the environment about the electronic device and participating in the financial transaction after causing the communication device of the electronic device to transmit the one or more financial transaction portion reimbursement messages.

6. The method of claim 1, wherein the automatically presenting the financial transaction dividing prompt identifying the one or more participants participating in the financial transaction and the corresponding portion of the transaction amount assigned to the each participant of the one or more participants is only presented in response to the one or more processors detecting a shared financial transaction trigger.

7. The method of claim 6, wherein the shared financial transaction trigger comprises a calendaring event stored in a calendaring application operating on the one or more processors that identifies a merchant.

8. The method of claim 6, wherein the shared financial transaction trigger comprises actuation of a user actuation target presented in another prompt presented in response to the one or more processors, using one or more sensors of the electronic device, identifying a financial transaction context within the environment of the electronic device.

9. The method of claim 6, wherein the shared financial transaction trigger comprises a location detector of the electronic device determining the electronic device is situated at a merchant location.

10. The method of claim 9, wherein the shared financial transaction trigger further comprises a communication device of the electronic device determining that multiple electronic devices are situated at the merchant location.

11. The method of claim 1, further comprising:
detecting, with a location detector of the electronic device, the electronic device exiting a location region associated with the financial transaction;
deleting, by the one or more processors from a memory associated with the electronic device, the one or more audio samples identifying the one or more participants situated within the environment about the electronic device and participating in the financial transaction after causing a communication device of the electronic device to transmit one or more financial transaction portion reimbursement messages; and
deactivating, by the one or more processors, the audio input device.

12. The method of claim 1, wherein the capturing, with the audio input device of the electronic device, the audio input from an environment about the electronic device occurs for less than a predefined duration from the detecting, with the one or more processors of the electronic device, the financial transaction using the digital wallet application operable on the one or more processors of the electronic device.

13. The method of claim 1, wherein the financial transaction dividing prompt is presented, by the one or more processors on the user interface of the electronic device, concurrently with details of the financial transaction.

14. An electronic device, comprising:
a user interface;
an audio input device; and
one or more processors operable with the user interface and the audio input device and operating a digital wallet application;
wherein
the one or more processors are configured to determine, from one or more audio signals captured by the audio input device, a plurality of individuals participating in a financial transaction executed by the digital wallet application and, in response, to present a prompt identifying both the plurality of individuals and a financial transaction portion amount; and
the prompt allows user input received by the user interface to manipulate the financial transaction portion amount attributed to the each individual of the plurality of individuals.

15. The electronic device of claim 14, wherein:
the financial transaction portion amount is attributed to each individual of the plurality of individuals; and
the one or more processors, in response to the user input, alter the financial transaction portion amount attributed to the each individual of the plurality of individuals by an amount defined by the user input.

16. The electronic device of claim 15, wherein:
the electronic device further comprises a communication device operable with the one or more processors;
the prompt comprises a financial transaction portion reimbursement message transmission user actuation target; and
the one or more processors, in response to actuation of the financial transaction portion reimbursement message transmission user actuation target, cause the communication device to transmit a plurality of financial transaction portion reimbursement messages to a plurality of remote electronic devices belonging to the plurality of individuals.

17. The electronic device of claim 16, further comprising a memory operable with the one or more processors, wherein the one or more processors further are configured to cause the audio input device to cease capturing the one or more audio signals in response to presentation of the prompt and to delete the one or more audio signals from the memory in response to the communication device transmitting the plurality of financial transaction portion reimbursement messages.

18. The method of claim 1, further comprising:
identifying, by one or more processors of the electronic device, one or more contextual signals indicative of the financial transaction being a probable group electronic financial transaction occurring in the digital wallet application operating on the one or more processors;
identifying, by the one or more processors from the audio input, a group of individuals participating in the probable group electronic financial transaction; and
detecting, by the one or more processors from the digital wallet application, an actual financial transaction occurring;
wherein the financial transaction dividing prompt identifies the group of individuals.

19. The method of claim 18, further comprising ceasing, by the audio input device, the capturing of the audio input upon the one or more processors presenting the financial transaction dividing prompt.

20. The method of claim 18, wherein the identifying the group of individuals participating in the probable group electronic financial transaction comprises comparing the audio input to one or more of previously captured voice call audio signals, previously captured video call audio signals, previously captured videos, or previously manually stored audio samples.
